(19) United States
(12) Patent Application Publication
(10) Pub. No.: US 2024/0302514 A1
(43) Pub. Date: Sep. 12, 2024

(54) OPTICAL-ACOUSTIC SHOOTER DETECTION AND LOCALIZATION, INCLUDING RAPID-FIRE EVENTS AND SIMULTANEOUS EVENTS

(71) Applicant: Elta Systems Ltd., Ashdod (IL)

(72) Inventors: Noam FRENKEL, Karney Yosef (IL); Erez SHARON, Karmei Yosef (IL); Ram WARHAFTIG, Yad Biyamin (IL); Slava KANDIBA, Ashdod (IL); Hen PINTO, Cesaria (IL)

(21) Appl. No.: 18/279,461

(22) PCT Filed: Mar. 3, 2022
(86) PCT No.: PCT/IL2022/050235

§ 371 Date: Aug. 30, 2023

(30) Foreign Application Priority Data
Mar. 11, 2021 (IL) 281534

(51) Int. Cl. G01S 11/16; G01S 3/783; G01S 3/808; G01S 5/16; G01S 5/18

(52) U.S. Cl. CPC G01S 11/16; G01S 3/783; G01S 3/8083; G01S 5/16; G01S 5/18

(57) ABSTRACT

A computerized system is configured to detect optical and acoustic events. It is operatively coupled to optical sensor(s) and acoustic sensor(s). It comprises a processing circuitry configured to perform the following: (a) receiving optical data from the optical sensor(s), indicative of optical event(s) associated with an event source(s). (b) receiving acoustic data from the acoustic sensor, indicative of acoustic event(s) associated with the event source. The optical sensor and the acoustic sensor are time-synchronized. (c) identifying the optical and acoustic events, based at least on the optical and acoustic data, (d) determining at least one of: distance and direction of the event source, relative to one or more of the optical sensor and the acoustic sensor. The determination is based at least on the optical event, the acoustic event, the optical data and the acoustic data.

### FIELD OF THE INVENTION

The present disclosure is in the field of detection and localization systems, in particular systems for detection and localization of weapons such as firearms.

### BACKGROUND OF THE INVENTION

Systems known in the art attempt to detect objects using systems that comprise optical or acoustic sensors.

### GENERAL DESCRIPTION

In accordance with a first aspect of the presently disclosed subject matter, there is presented a computerized system configured to detect optical and acoustic events, the system configured to be operatively coupled to at least one optical sensor and at least one acoustic sensor, the computerized system comprising a processing circuitry configured to perform the following method:
(a) receiving optical data from the at least one optical sensor, the optical data being indicative of at least one optical event associated with at least one event source;
(b) receiving acoustic data from the at least one acoustic sensor, the acoustic data being indicative of at least one acoustic event associated with the at least one event source,
wherein the at least one optical sensor and the at least one acoustic sensor are time-synchronized;
(c) identifying the at least one optical event and the at least one acoustic event, based at least on the optical data and on the acoustic data; and
(d) determining at least one of: distance of the at least one event source and a direction of the at least one event source, relative to one or more of the at least one optical sensor and the at least one acoustic sensor, wherein the determination is based at least on the at least one optical event, the at least one acoustic event, the optical data and the acoustic data.

In addition to the above features, the system according to this aspect of the presently disclosed subject matter can include one or more features (i) to (xlii) listed below, in any desired combination or permutation which is technically possible:
(i) the optical data is associated with at least one optical-data time stamp,
   wherein the acoustic data is associated with at least one acoustic-data time stamp,
   wherein the determination of the distance in said step (d) comprises performing the following:
   (i) determining at least one optical-event time stamp of the at least one optical event, based on the at least one optical-data time stamp;
   (ii) determining at least one acoustic-event time stamp of the at least one acoustic event, based on the at least one acoustic-data time stamp;
   (iii) determining at least one first time difference between the at least one acoustic-event time stamp and the at least one optical-event time stamp; and
   (iv) determining the distance based on the at least one first time difference.
(ii) the determination of the distance is based on a speed of sound and a speed of light.
(iii) the event source is a weapon.
(iv) the weapon is one of a small arm, an artillery piece, a mortar, a rocket, a missile.
(v) the weapon is an automatic weapon.
(vi) the optical event is associated with a flash of firing of a projectile.
(vii) the acoustic event is associated with at least one of: a blast associated with the firing of a projectile, a shock wave associated with the firing of a projectile.
(viii) the acoustic sensor comprises one acoustic vector sensor, wherein the determining of the direction of the at least one event source is based at least on the acoustic data.
(ix) the at least one acoustic sensor comprises a plurality of acoustic sensors,
   wherein the determining of the direction of the at least one event source is based at least on the acoustic data,
   wherein the determining of the direction of the at least one event source is based at least on a first acoustic-event time stamp associated with a first acoustic sensor of the plurality of acoustic sensors and at least one second acoustic-event time stamp associated with at least one other acoustic sensor of the plurality of acoustic sensors.
(x) the determining of the direction of the at least one event source is based at least on a second acoustic-event time difference between the first acoustic-event time stamp and the at least one second acoustic-event time stamp.
(xi) the determining of the direction of the at least one event source is based at least on the optical data.
(xii) the method further comprising:
   (e) classifying optical-acoustic-related events associated with the optical event(s) and the acoustic events.
(xiii) the classifying is based on optical patterns associated with the optical events and on acoustic patterns associated with the acoustic events,
   thereby enabling an enhanced-accuracy classification of the optical-acoustic-related events, having enhanced accuracy compared to a second classification which is based on only one of on optical patterns and acoustic patterns.
(xiv) wherein an object is moving from the event source, wherein the event source is a weapon, wherein the object is a projectile fired from the weapon, wherein the method further comprising:
   (f) determining a speed of movement of the object, based at least the determined distance and on one or more acoustic-event time stamps corresponding to at least one shockwave acoustic event.
(xv) wherein an object is moving from the event source, wherein the event source is a weapon, wherein the method further comprising:
   (g) determining a direction of movement of the object, based at least on the determined distance of the at least one event source, on the direction of the at least one event source and on the speed of movement of the object.
(xvi) the optical sensor comprises an optical diode.
(xvii) the optical sensor comprises a camera.
(xviii) the acoustic sensor comprises a microphone.
(xix) the at least one event source comprises one event source.
(xx) the at least one event source comprises a plurality of event sources.
(xxi) the at least one optical event comprises a plurality of optical events, wherein the at least one acoustic event comprises a plurality of acoustic events,
   wherein said step (d)(iii) comprises determining a plurality of first time differences between acoustic-event time stamps and corresponding optical-event time stamps,
   wherein said step (d)(iv) comprises determining the distance of the at least one event source based at least on the plurality of first time differences,
   thereby deriving an enhanced-accuracy distance of the at least one event source, having enhanced accuracy compared to a second distance determined based on a second single time difference between a single acoustic-event time stamp and a corresponding single optical-event time stamp.
(xxii) the determining of the distance comprises calculating an average of a plurality of determined distances.
(xxiii) the at least one optical event comprises a plurality of optical events, wherein the at least one acoustic event comprises a plurality of acoustic events,
   wherein said step (d)(iii) comprises determining a plurality of first time differences between acoustic-event time stamps and corresponding optical-event time stamps,
   wherein said step (d)(iv) comprises determining the direction of the at least one event source based at least on the plurality of first time differences,
   thereby deriving an enhanced-accuracy direction of the at least one event source, having enhanced accuracy compared to a second direction determined based on a second single time difference between a single acoustic-event time stamp and a corresponding single optical-event time stamp.
(xxiv) the determining the direction comprises calculating an average of a plurality of determined directions.
(xxv) wherein, in said step (d)(iii), the determining at least one first time difference comprises calculating an average time difference of the plurality of first time differences.
(xxvi) a distance accuracy of the determined distance is less or equal to 10 meters.
(xxvii) a distance accuracy of the determined distance is less or equal to 1 meter.
(xxviii) a distance accuracy of the determined distance is less or equal to 0.1 meter.
(xxix) the at least one optical event comprises a plurality of optical events, wherein the at least one acoustic event comprises a plurality of acoustic events, wherein the method further comprising:
   (h) grouping optical events of the plurality of optical events and acoustic events of the plurality of acoustic events, based on repetition of first time differences between pairs of optical events and acoustic events, thereby deriving at least one optical-acoustic group,
   thereby enabling a differentiation of multiple event sources, based on the grouping, in a situation of overlapping events.
(xxx) the grouping of the optical events and of the acoustic events comprises:
   a. determining a plurality of first time differences between acoustic-event time stamps of the plurality of acoustic events and an optical-event time stamp of each optical event of the plurality of optical events; and
   b. identifying the repetition of the first time differences based on the determined plurality of first time differences.
(xxxi) the repetition of the time differences correlates to a single event-source distance.
(xxxii) the grouping comprises matching individual acoustic events of the at least one optical-acoustic group with individual optical events of the at least one optical-acoustic group.
(xxxiii) the determination of the distance in said step (d) is based on the repeated time differences of the at least one optical-acoustic group.
(xxxiv) the determining of the direction of the at least one event source comprises determining a second direction of the event source associated with the at least one optical-acoustic group.
(xxxv) the at least one event source comprises a plurality of event sources,
   wherein said step (h) comprises deriving a plurality of optical-acoustic groups, wherein the method further comprising:
   (i) associating an optical-acoustic group of the plurality of optical-acoustic groups with an event source of the plurality of event sources.
(xxxvi) the method further comprising performing, prior to said step (h):
   (j) perform an initial grouping of optical events based on directions of the optical events and/or optical patterns associated with the optical events, thereby deriving initial group(s) of related optical events.
   (k) perform an initial grouping of acoustic events based on directions of the optical events and/or acoustic patterns associated with the acoustic events, thereby deriving initial group(s) of related acoustic events.
(xxxvii) the method further comprising:
   (l) determining third optical-event time intervals associated with a group of optical events of the at least one optical-acoustic group;
   (m) determining fourth acoustic-event time intervals associated with a group of acoustic events of the at least one optical-acoustic group; and
   (n) classifying the at least one event source based at least on the fourth acoustic-event time intervals and/or on the third optical-event time intervals.
(xxxviii) the classifying of the at least one event source comprises:
   i. determining an event rate based at least on the fourth acoustic-event time intervals and/or on the third optical-event time intervals; and
   ii. classifying the at least one event source based at least on the determined event rate.
(xxxix) the determining of the event rate comprises calculating at least one of an average acoustic time interval and an average optical time interval.
(xl) the classifying of the at least one event source based at least on the determined event rate comprises a table lookup.
(xli) the said step (d)(iii) comprises determining time differences between acoustic-event time stamps of the second individual acoustic events and corresponding optical-event time stamps of the second individual optical events, thereby deriving a plurality of time differences,
   wherein said step (d)(iv) comprises determining at least one of the distance of the at least one event source and the direction of the at least one event source based on the plurality of time differences,
   thereby deriving at least one of an enhanced-accuracy distance of the at least one event source and an enhanced-accuracy direction of the at least one event source, having enhanced accuracy compared to a second distance and a second direction determined based on a second single time difference between a single acoustic-event time stamp and a corresponding single optical-event time stamp.
(xlii) the determining the time differences comprises calculating an average time difference between the acoustic-event time stamps and the corresponding optical-event time stamps.

In accordance with a second aspect of the presently disclosed subject matter, there is presented a system comprising:
I. the computerized system of the first aspect of the presently disclosed subject matter;
II. the at least one optical sensor; and
III. the at least one acoustic sensor.

This aspect can optionally further comprise one or more of features (i) to (xlii) listed above, mutatis mutandis, in any technically possible combination or permutation.

In accordance with a third aspect of the presently disclosed subject matter, there is presented the computerized method performed by the computerized systems of any of the above aspects of the presently disclosed subject matter.

In accordance with a fourth aspect of the presently disclosed subject matter, there is presented a non-transitory program storage device readable by a computer, tangibly embodying computer readable instructions executable by the computer to perform the computerized method performed by the computerized systems of the above aspects of the presently disclosed subject matter.

The computerized method and the non-transitory program storage device, disclosed herein according to various aspects, can optionally further comprise one or more of features (i) to (xlii) listed above, mutatis mutandis, in any technically possible combination or permutation.

### BRIEF DESCRIPTION OF THE DRAWINGS

In order to understand the invention and to see how it may be carried out in practice, some specific embodiments will now be described, by way of non-limiting example only, with reference to the accompanying drawings, in which:

FIG. 1 is a schematic illustration of a non-limiting example of a firing weapon, according to some embodiments of the presently disclosed subject matter;

FIG. 2 is a schematic illustration of a non-limiting example of a system which can detect and localize events such as firing of weapons, according to some embodiments of the presently disclosed subject matter;

FIG. 3 is a schematic illustration of a non-limiting example of a system which can detect and localize events such as firing of weapons, according to some embodiments of the presently disclosed subject matter;

FIGS. 4A and 4B are a generalized illustration of a non-limiting example of captured optical data, according to some embodiments of the presently disclosed subject matter;

FIG. 5 is a schematic illustration of a non-limiting example of a generalized schematic diagram comprising Optical-Acoustic Detection System, in accordance with some embodiments of the presently disclosed subject matter;

FIG. 6 schematically illustrates a non-limiting example generalized depiction of optical data and acoustic data, in accordance with some embodiments of the presently disclosed subject matter;

FIG. 7 schematically illustrates a non-limiting example generalized depiction of optical data and acoustic data, in accordance with some embodiments of the presently disclosed subject matter;

FIG. 8 schematically illustrates a non-limiting example of a generalized flow diagram for event source detection and location, in accordance with some embodiments of the presently disclosed subject matter;

FIG. 9 schematically illustrates a non-limiting example of a generalized flow diagram for event source detection, in accordance with some embodiments of the presently disclosed subject matter; and

FIG. 10 schematically illustrates a non-limiting example of a generalized flow diagram for event source classification, in accordance with some embodiments of the presently disclosed subject matter.

### DETAILED DESCRIPTION OF THE INVENTION

In the following description the invention will be illustrated with reference to specific embodiments of a system and method in accordance with the invention. It may be appreciated, that the invention is not limited to such use and the illustrated embodiment is illustrative to the full scope of the invention as described and claimed herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. While the invention has been shown and described with respect to particular embodiments, it is not thus limited.

As used herein, the phrase “for example,” “such as” and variants thereof describing exemplary implementations of the present invention are exemplary in nature and not limiting.

As used herein, the terms “one or more” and “at least one” aim to include one as well any number greater than one e.g. two, three, four, etc.

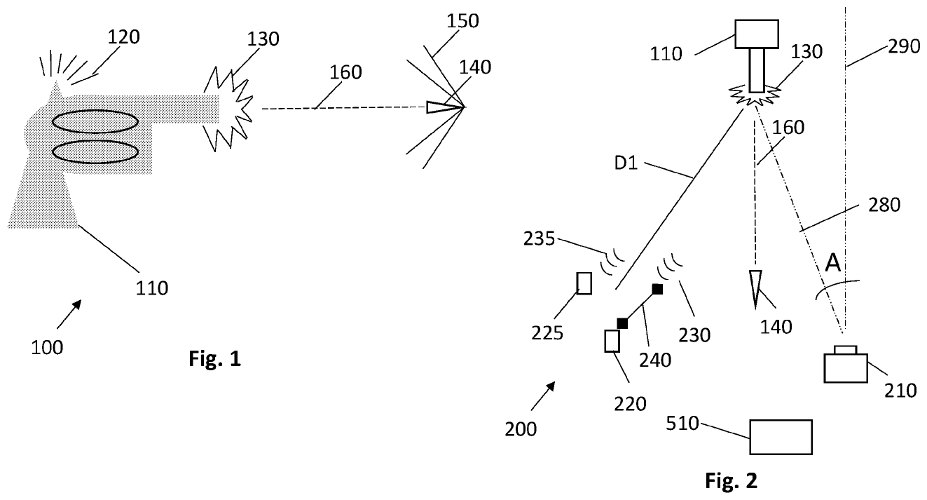

FIG. 1 is a schematic illustration of a non-limiting example of a firing weapon, according to some embodiments of the presently disclosed subject matter. In this example, the scenario 100 illustrates the firing of a firearm or other weapon 110. In the example, the weapon is a small arm 110, e.g. a pistol 110. When weapon is fired, a muzzle blast 120 occurs in some examples, e.g. associated with the firing of the projectile. The sound of the blast 120 is an acoustic event, which in some cases can be detected by an acoustic sensor. Also, there is in some cases a flash 130, visible e.g. at the muzzle of weapon 110, e.g. associated with the firing of the projectile. The flash 130 is an optical event, which in some cases can be detected by an optical sensor. The bullet 140 or other projectile 140 travels 160 through the air. The projectile 140 generates a shockwave 150, in a case where its speed is faster than the speed of sound. The shockwave sound is another example of an acoustic event, which in some cases can be detected by an acoustic sensor. Typically, a shockwave travels arrives at an acoustic sensor earlier than does a muzzle blast. A muzzle blast is disclosed herein as a non-limiting example of a blast.

Note that weapon 110 is a non-limiting example of an event source. An event source is any source, e.g. any object, which is associated with events that have an acoustical and optical signature Other non-limiting examples of event sources include a bomb or other explosive device exploding, door which is slamming shut, a car engine starting, a car which is braking on a street, a dog barking, a person shouting, artillery shells and other projectiles which are fired and land at e.g. a target etc.

FIG. 2 is a schematic illustration of a non-limiting example of a system 505 which can detect and localize events such as firing of weapons, according to some embodiments of the presently disclosed subject matter. In this example, the scenario 200 illustrates the firing of a weapon 110. In the example of the figure, there are deployed one or more optical sensors 210. Optical sensor 210 can be any type of imaging device, e.g. a camera, optical diode etc. Non-limiting examples of camera 210 are a microphone are visible-spectrum camera, an infra-red (IR) camera (e.g. shortwave IR (SWIR) and medium-wave IR (MWIR) cameras), a thermal camera and a charge-coupled-diode (CCD) camera. Optical sensor 210 is an example of an Electro-Optical (EO) sensor.

In the example of the figure, there are also deployed one or more acoustic sensors 220, 225. A non-limiting example of acoustic sensors 220, 225 is a microphone. The various sensors are deployed or configured with a known geometric relationship between them (in terms of position and orientation/direction of each). The relationship between the coordinate systems of each of their orientations is known.

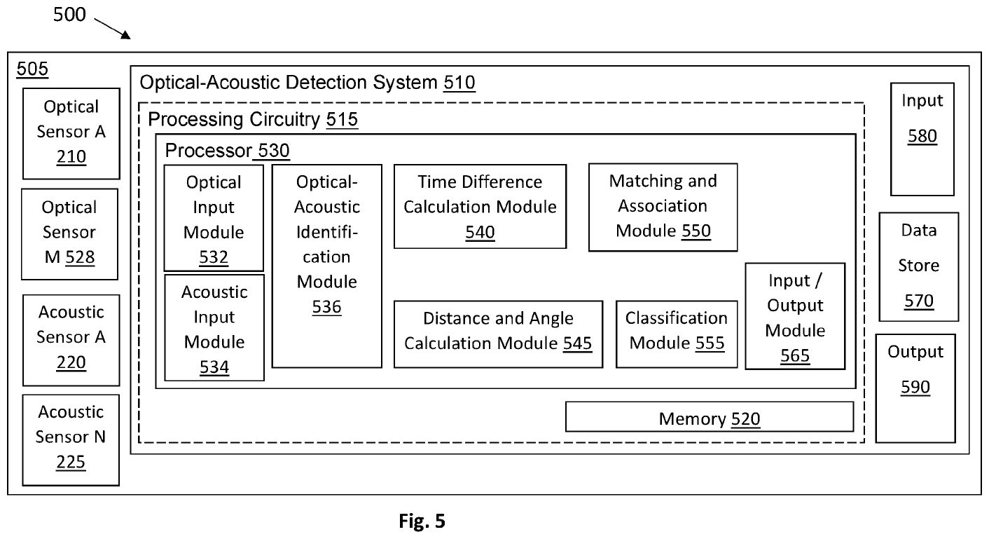

The various sensors are operatively coupled to computerized Optical-Acoustic Detection System 510, which is disclosed in more detail further herein with reference to FIG. 5. Computerized system 510 is in some examples configured to enable detection, identification, localization and/or classification of optical and acoustic events. It is therefore be referred to herein, in some examples, also as Optical-Acoustic Identification System 510, as Optical-Acoustic Localization System 510 and/or as Optical-Acoustic Classification System 510.

In the example, weapon 110 fires, thus ejecting 160 the projectile 140.

In some operational scenarios, e.g. in a combat or anti-terrorism scenario, it is required to be able to detect, with confidence, occurrence of the firing event and the time of occurrence, and to localize the event with sufficient accuracy. For example, it may be required to determine the position of the weapon or other source of an event. For example, it may be required to determine the distance of the source from one or more sensors, and/or the direction of the source relative to the one or more sensors.

The flash 130 is visible to optical sensor(s) 210, which can sense 280 and capture an image that includes the flash, and possibly includes the weapon, and can generate optical data which include the flash. Flash 130 is a non-limiting example of an optical event. Similarly, acoustic events such as blast 120 and shock wave 150 are audible and can be captured 230, 235 by acoustic sensor(s) 220, 225. The acoustic sensor(s) can generate acoustic data which include the captured acoustic events. Each capture of data (e.g. of each optical and/or acoustic event, e.g. of each flash or muzzle blast captured) can be associated with a corresponding time stamp of the capture.

As indicated above, typically a shockwave arrives at an acoustic sensor 220, 225 before the corresponding muzzle blast arrives at the acoustic sensor.

In the example, the optical sensor(s) and the acoustic sensor(s) are synchronized in time with each other. Thus, when system 510 analyzes time stamps of the optical data and of acoustic data, it can synchronize between these time stamps, know their order and the time intervals between them.

In some examples, the system 510 is configured to identify the optical event(s) based on the optical data, and to identify the acoustic event(s) based on the acoustic data. That is, it is capable to analyze the data, and determine that events occurred. In some examples, the system is capable of classifying these events. The system 510 is in some examples further configured to determine optical-event time stamp(s), that is the time stamps of occurrence of optical event(s), based on the time stamps of the optical data. The system 510 is in some examples further configured to determine acoustic-event time stamp(s), that is the time stamps of occurrence of acoustic event(s), based on the time stamps of the acoustic data. More detail concerning these actions is disclosed further herein with reference to FIGS. 4, 6 and 7.

As will be disclosed further herein, a combined optical-acoustic detection/classification/location system can provide, in some examples, at least one or more of the following technical advantages:
(a) distinguish between individual acoustic and/or optical events, in a case of overlapping and/or rapid-fire/rapid-occurrence events
(b) associate individual optic events and individual acoustic events with a corresponding optical-acoustic-related event, in a case of overlapping and/or rapid-fire events
(c) distinguish between event sources 110, in a case of multiple event sources 110
(d) associate specific optical and acoustic events 120, 130, 150 with specific event sources 110
(c) calculate a distance of the event source 110, from the sensor(s) 210, 220, 225, in a comparatively more accurate manner, based on the combination of optical and acoustic sensor data
(f) calculate a distance and/or direction of the event source 110, from the sensor(s) 210, 220, 225, in a comparatively more accurate manner, based on e.g. averaging of data from the multiple events, in a case of overlapping and/or rapid-fire events
(g) classify in a more accurate manner optical-acoustic-related events which are associated with optical event(s) and the acoustic events, e.g. based on optical patterns and acoustic patterns
(h) determine a direction of fire of the projectile 140, in a comparatively more accurate manner
(i) obtain forensic information about characteristics of an event source 110, e.g. firing rate, classification of weapon 110, and speed of fired projectile 140.
(j) achieve high-accuracy distance calculation, using relatively inexpensive solution such as solutions utilizing simple diodes.

Before continuing with the disclosure with reference to FIG. 2, attention is now drawn to FIGS. 4A and 4B, providing a generalized illustration of a non-limiting example of captured optical data, according to some embodiments of the presently disclosed subject matter. In the example of FIG. 4A, the optical data is image 410, which is captured by optical sensor 210 at a time t2. The example image 410 is indicative of one optical event 413, which were captured at t2. In this example, t2 is the optical event time stamp. In the example of FIG. 4B, the optical data is image 430, which is captured by optical sensor 210 at a time t3. The example image 430 is indicative of one optical event 423, which was captured at t3. In this example, t3 is the optical event time stamp. System 510 is configured to detect/identify that the two events 413 and 423 are represented on images 410 and 423, respectively.

In some examples, system 510 is configured to classify the events, e.g. to determine that the two captured events 413, 423 are both flashes of a gun or other weapon.

Note that FIG. 4 illustrate a case where two events are not simultaneous, e.g. two weapons are fired not at exactly the same time, and thus two images capture the two events. In a case of simultaneous firing, one captured image 410 would indicated both events 413 and 423.

In some examples, the classification of an optical event is performed at least partly based on the acoustic event. For example, the captured optical data may be ambiguous, but based on the captured sound of a muzzle blast it can be determined that the optical event is a gun flash. In some examples, the classification of an acoustic event is performed at least partly based on the optical event. For example, the captured acoustic data may be ambiguous, but based on the captured image of a flash it can be determined that the acoustic event is the sound of a muzzle blast.

Reverting to FIG. 2, determination of the distance D1 of source 110 from one or more of the sensors 210, 220, 225 can be performed with relatively high accuracy, by looking at both the optical data and the acoustic data and their respective time stamps, which are synchronized with each other. The method can also determine a time difference between acoustic-event time stamp(s) and corresponding optical-event time stamp(s), and can consider the speed of light and the speed of sound. The determination of the direction can be performed, for example, using methods known in the art.

In some other examples, distance can be estimated based on the time difference between two acoustic events associated with a single event such a gunshot, e.g. the time delay between shockwave event and a corresponding muzzle blast event associated with the same gunshot by the same gun.

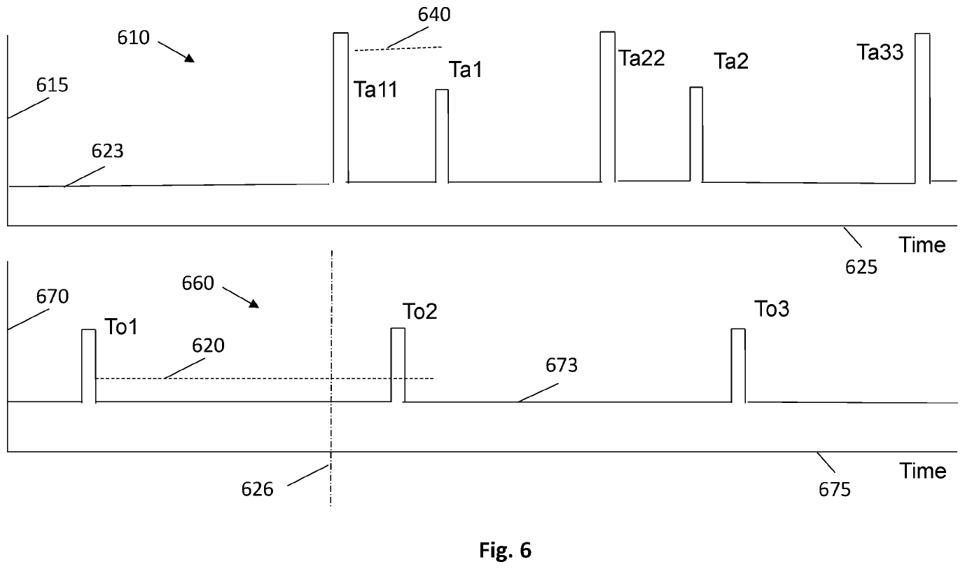

More detail concerning such distance determination methods is disclosed with reference to FIGS. 5 and 6, and the flowcharts, further herein.

Determination of the direction of source 110, relative to or more of the sensors 210, 220, 225 can be performed using one or more of at least several methods. In some examples, determining the direction of the event source(s) is based at least on the optical data. Considering again the example image 410 of FIG. 4, the system 510 knows that optical sensor 210 is configured to face in the direction 290. Based on this direction 290, and on the relative positions 413, 423 on image 410 of the two optical events 413, 423, system 510 can determine the direction of each event, and thus of each event source, relative to optical sensor 210. In the example of FIG. 2, system 510 can determine that weapon 110 is at a direction 280 that is at an angle A relative to the facing direction 290 of optical sensor 210. The determination of the direction can be performed, for example, using methods known in the art. In some cases, the accuracy of such a direction calculation is based at least on the lens width. In some cases, it is also a function of the optical sensor resolution.

In another non-limiting example, the system 505 comprises multiple optical sensors, which are simple optical diodes 210, e.g. each comprising one pixel, measuring light strength. If each optical diode faces a different direction, the detection of light in a particular optical diode 210 can serve as an indication that there is an event source (110) located in that particular direction.

In some other examples, the direction can be calculated based at least on the acoustic data captured by a single acoustic sensor 220. This can occur, for example, when the acoustic sensor 220 is an acoustic vector sensor. The determination of the direction can be performed, for example, using methods known in the art.

In some other examples, the direction can be calculated based at least on the acoustic data captured by multiple acoustic sensors 220, 225. For example, the calculation can be based at least on a first acoustic-event time stamp T-220 associated with a first acoustic sensor 220 and at least one second acoustic-event time stamp T-225 associated with one or more other acoustic sensor(s) 225. In the example, T-220 and T-225 are associated with the same acoustic event, e.g. the same blast 120. In one example of the method, the time difference 240 of the two acoustic-event time stamps, e.g. T-225 minus T-220, is calculated. This timed difference between the two acoustic-event time stamps is referred to herein also as a second acoustic-event time difference, to distinguish it from other time differences disclosed herein. If the relative positions of acoustic sensors 220 and 225 are known, then the direction of the event source 110 can be determined based on the time difference 240. The determination of the direction can be performed, for example, using methods known in the art. Note that in some cases, a large distance between two acoustic sensors will yield a more accurate direction calculation.

In still other examples, the direction of event source 110 can be determined utilizing a combination of methods. For example, a direction which is determined based on the use of two acoustic sensors, and a direction which is determined based on the optical sensor, can be averaged. (Such a calculation can consider the positions of the optical sensor and the acoustic sensors relative to each other, in a case where they are not in identical positions.) In some examples, this can have the advantage of increasing the accuracy of the calculated direction of the event source 110.

Note that in the presently disclosed subject matter, the terms “event detection” or “event identification” refer to the determination that a particular event occurred, e.g. “an optical event occurred at time t4”. The term “event localization” refers to determination of the position, for example distance and/or direction, of the source of the event, e.g. “optical event X occurred at an event source that is located 45 degrees to the left of optical sensor 210” or “acoustic event Y occurred at an event source that is located at a distance of 1.2 kilometers from acoustic sensor 220”. The term “event classification” refers to the nature of the event, e.g. “acoustic event Y is a muzzle blast”, “acoustic event Z is a door slamming”, “optical event X is a flash”.

In some examples, weapon 110 is one of a small arm (e.g. rifle, machine gun, sub-machine gun, assault rifle, pistol), an artillery piece, a mortar, a rocket or a missile. One non-limiting example of the use of the presently-disclosed subject matter is for artillery ranging.

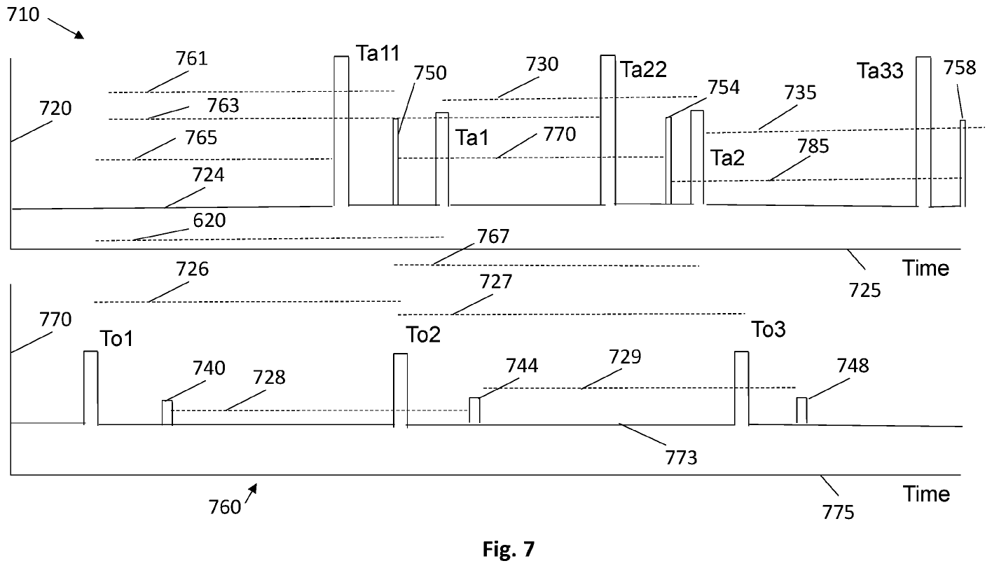

In some examples, weapon 110 is a semi-automatic or automatic weapon firing multiple rounds or other projectiles, in some cases in rapid fire. This is further exemplified further herein with reference to FIGS. 6 and 7. Rapid fire is disclosed here as a non-limiting example of the rapid occurrence of optical-acoustic-related events.

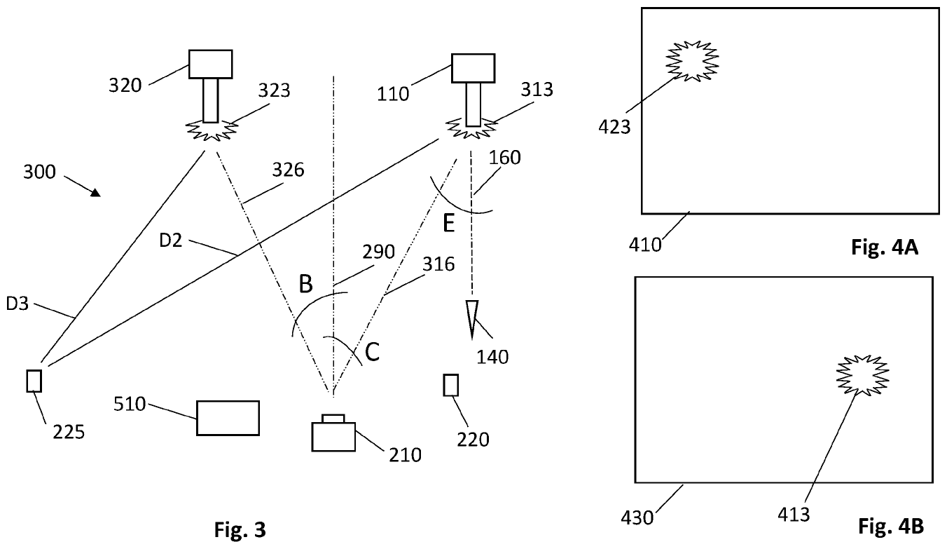

Attention is now turned to FIG. 3, depicting a schematic illustration of a non-limiting example of a system which can detect and localize events such as firing of weapons. The scenario 300 is similar to scenario 200, except that in it a plurality of weapons 110, 320 or other event sources are depicted. As each weapon is fired, each has a corresponding flash 313, 323, and muzzle blast 120 and/or shockwave 150. In such a scenario, Optical-Acoustic Localization System 510 is configured such that, for example, the acoustic sensors 220, 225 are capable of measuring the corresponding distances D2, D3 of each event source, and, for example, the optical sensor 210 is capable of measuring the angles B, C of the directions 316, 326 of each of the event sources relative to a direction 290 of facing of the optical sensor.

The direction of the firing 160 of projectile 140 from event source, relative to the optical and/or the acoustic sensors 210, 220, 225, is shown schematically as angle E.

Note that in the non-limiting example of FIG. 2, there are two acoustic sensors 220, 225, co-located, and both sensors are positioned on the same side of the optical sensor 210. In other examples, the acoustic sensors are positioned at a different distance from each other. In the non-limiting example of FIG. 3, the acoustic sensors are positioned on different sides of optical sensor 210.

Similarly, the number of optical sensors and of acoustic sensors can vary in different examples.

Example advantages of detecting/identifying, localizing and/or classifying events and event sources based on a combination of optical and acoustic sensor data, rather than using only one or the other, are disclosed further herein.

Attention is again turned to FIG. 4. This image 410 corresponds to scenario 300, and thus the images or appearances 413, 423 of two flashes appear on image 410, corresponding to the two flashes 313, 323 associated with the firing 160 by event sources 110, 320.

Attention is now drawn to FIG. 5, schematically illustrating a non-limiting example of a generalized schematic diagram 500 of a system 505 comprising Optical-Acoustic Detection System 510, in accordance with some embodiments of the presently disclosed subject matter. System 505 in some examples is configured to sense optical and acoustic events, and to detect, identify, localize and/or classify them. System 505 is referred to herein also as combined optical-acoustic solution 505. In some examples, the detection and location can be performed in an automatic fashion.

System 505 comprises one or more optical sensors 210, 598 as well as one or more acoustic sensors 220, 225. The example of the figure shows a number M of optical sensors and a number N of acoustic sensors.

In some examples, system 505 also comprises Optical-Acoustic Detection System 510. In some examples, sensors 210, 220, 225 are operatively coupled to system 510. Although in the figure the sensors and system 510 are shown in a single box and thus appear to be co-located, in some other examples they are not co-located, e.g. as disclosed with reference to FIG. 3.

In some non-limiting examples, Optical-Acoustic Detection System 510 includes a computer. It way, by way of non-limiting example, comprise a processing circuitry 515. This processing circuitry may comprise a processor 530 and a memory 520. This processing circuitry 530 may be, in some non-limiting examples, general-purpose computers specially configured for the desired purpose by a computer program stored in a non-transitive computer-readable storage medium. They may be configured to execute several functional modules in accordance with computer-readable instructions. In other non-limiting examples, this processing circuitry 515 may be a computer(s) specially constructed for the desired purposes.

Processor 530 may comprise, in some examples, at least one or more functional modules. In some examples it may perform at least functions, such as those disclosed herein with reference to FIGS. 2, 3, 4, and 6-10.

In some examples, processor 530 comprises optical input module 532. In some examples, this module is configured to receive optical data from one or more optical sensors 210.

In some examples, processor 530 comprises acoustic input module 534. In some examples, this module is configured to receive acoustic data from one or more acoustic sensors 220, 225.

In some examples, processor 530 comprises optical-acoustic identification module 536. In some examples, this module is configured to analyze the optical data (e.g. image 410) captured at one or more optical sensors 210, and to analyze the acoustic data captured at the one or more acoustic sensors 220, 225, and to detect or identify optical events and acoustic events, such as flash 130, 313, 323, muzzle blast 120 and shock wave 150, based on the data. This identification is in some examples using known per se methods. For example, the module may consult data store 570, which contains reference optical data associated with various optical events (e.g. flash, movement of a vehicle or person etc.), and match the received optical data with the stored reference data. For example, the module may consult data store 570, which contains reference acoustic data associated with various acoustic events (e.g. muzzle blast, shockwave, explosion of explosive, movement of a vehicle etc.), and match the received acoustic data with the stored reference acoustic data. In some examples both optical and acoustic data are analyzed, in order to make a determination that an optical event and/or acoustic event occurred.

In some examples, processor 530 comprises time difference calculation module 540. In some examples, this module is configured to calculate various time differences, for example differences between optical and acoustic timestamps associated with an event such as shooting a projectile, and/or differences 240 between two acoustic time stamps. Other example time differences are disclosed further herein with reference to FIGS. 6-10.

In some examples, processor 530 comprises distance and direction calculation module 545. In some examples, this module is configured to calculate distances between event sources and one or more sensors, and/or to determine the directions of the event sources relative to one or more sensors. In some examples, this module also calculates the speed of movement of objects. More detail on these functions is disclosed further herein.

In some examples, processor 530 comprises matching and association module 550. In some examples, this module is configured to match events and/or time intervals, and to associate events and groups of events with each other. More detail on these functions is disclosed further herein, with reference to FIGS. 6-10.

In some examples, processor 530 comprises classification module 555. In some examples, this module is configured to classify events and/or event sources. More detail on these functions is disclosed further herein, with reference to FIGS. 6-10.

In some examples, processor 530 comprises input/output module 565. In some examples, this module is configured to interface between input 580, and output 590, and the other modules of processor 530.

In some examples, memory 520 of processing circuitry 515 is configured to store data at least associated with the calculation of various parameters disclosed herein, e.g. time differences, distances, directions etc., as well as storing data associated with identification, classification, matching and association of events and of event sources.

In some examples, system 510 comprises a database or other storage 570. In some examples, storage 570 stores data that is relatively more persistent than the data stored in memory 520. For example, data store 570 may store reference optical and acoustic data associated with optical and/or acoustic events and event sources, patterns etc., which are used e.g. to identify and/or to classify events and event sources.

The example of FIG. 5 is non-limiting. In other examples, other divisions of data storage between storage 570 and memory 520 may exist.

In some examples, system 510 comprises input 580 and/or output 590 interfaces. In some examples, these 580 and 590 interface between processor 530 and various external systems and devices (not shown). The interfaces can, for example allow input of system configuration data and of event reference data (by computers, keyboards, displays, mice etc.), as well as output to user devices (printers, computers, terminals, displays etc.) the information determined by system 510, e.g. the locations and/or classifications of various events and event sources.

FIG. 5 illustrates only a general schematic of the system architecture, describing, by way of non-limiting example, certain aspects of the presently disclosed subject matter in an informative manner, merely for clarity of explanation. It will be understood that the teachings of the presently disclosed subject matter are not bound by what is described with reference to FIG. 5.

Only certain components are shown, as need to exemplify the presently disclosed subject matter. Other components and sub-components, not shown, may exist. Systems such those described with reference to FIG. 5 may be capable of performing all, some, or part of the methods disclosed herein.

Each system component and module in FIG. 5 can be made up of any combination of software, hardware and/or firmware, as relevant, executed on suitable device or devices, which performed the functions as defined and explained herein. The hardware can be digital and/or analog. Equivalent and/or modified functionality, as described with respect to each component and module, can be consolidated or divided in any other manner. Thus, in some embodiments of the presently disclosed subject matter, the system may include fewer, more, modified and/or different components, modules and functions than those shown in FIG. 5. To provide one non-limiting example of this, in some examples input/output module 565 is replaced by separate input and output modules. Similarly, in some examples matching and association module 550 and classification module 555 are combined into one module. Similarly, in some examples time difference calculation module 550 and distance and angle calculation module 545 are combined. Similarly, in some examples optical events and acoustic events are identified/detected separately, using separate optical identification modules and acoustic identification modules, thus replacing Optical-Acoustic Identification Module 536. Similarly, in some examples separate modules determine distance and direction, thus replacing Distance and Angle Calculation Module 545.

One or more of these components and modules can be centralized in one location, or dispersed and distributed over more than one locations, as is relevant.

Each component of FIG. 5 may represent a plurality of the particular component, possibly in a distributed architecture, which are adapted to independently and/or cooperatively operate to process various data and electrical inputs, and for enabling operations related to optical-acoustic detection and localization. In some cases, multiple instances of component may be utilized for reasons of performance, redundancy and/or availability. Similarly, in some cases, multiple instances of a component may be utilized for reasons of functionality or application. For example, different portions of the particular functionality may be placed in different instance of the component.

Communication between the various components of the systems of FIG. 5, in case where they are not located entirely in one location or in one physical components, can be realized by any signaling system or communication components, modules, protocols, software languages and drive signals, and can be wired and./or wireless, as appropriate. The same applies to interfaces such as 580, 590.

Attention is now drawn to FIG. 6, schematically illustrating a non-limiting example generalized depiction of optical data 673 and acoustic data 623, in accordance with some embodiments of the presently disclosed subject matter. The figure shows graphs 610 and 660 of acoustic and optical data, respectively, along time axes 625, 675. The Y axes 615, 670 depict the amplitude of signals detected by optical and acoustic sensors 210, 220, e.g. light power and sound power. In one simplified example, the optical data 673 is associated with a simple optical diode 210, detecting light energy. In the example, optical events such as firing flashes 130 occurred at times To1, To2, To3, where “o” refers to “optical” and the number is the order of the event.

Note that in other examples, using other types of sensors the Y axes 615, 670 can represent “Yes/No” the occurrence of an event, rather than e.g. power amplitudes. Similarly, in an example where the optical sensor is e.g. a camera, and captures an image, instead of the graph 660 shown there would be shown a sequence of images, captured at different times.

Looking at the acoustic graph 610, acoustic data 623 shows, for example, that there were three (3) muzzle blasts 120, associated with the firing of weapon 110, at the times Ta1, Ta2, (as well as Ta3, not shown), where “a” refers to “acoustic” and the number is the order of the event. Also shown the three resultant shockwaves, occurring at times Ta11, Ta22 and Ta33. It can be seen that there is a time delay 640 between the time Ta11, 626 of a shockwave 150 caused by a projectile 140, and muzzle blast 120 when the projectile 140 is fired.

It was disclosed earlier that the optical and acoustic sensors are time-synchronized with each other. Therefore, in the example of FIGS. 6 and 7, it is assumed that time lines of the acoustic and optical plots 610, 660 are the same. Note also additional sensors (e.g. second acoustic sensor 225) will generate data that can be represented by additional optical and/or acoustic graphs, as relevant (not shown in FIG. 6 or 7).

It should be noted that, since light travels at a higher speed than does sound, the time To1 of the first flash precedes the time Ta1 of the corresponding first muzzle blast 120, which are associated with the same event of firing a particular bullet or other projectile. In some examples, time difference calculation module 540 calculates a time difference 620 between the two time stamps Ta1 and To1. The time difference between corresponding acoustic-event time stamps Ta1 and corresponding optical-event time stamps To1 is referred to herein also as a first time difference, or first time interval, to distinguish this time difference from other time differences disclosed herein.

In some examples, since the speed of light is so much higher than the speed of sound (for any sound medium and at any altitude), the speed of light is taken to be infinite, and thus the time “T-event” of actual occurrence of the event, e.g. the firing of the bullet by the weapon, is assumed to be that of the optical-event time stamp To1. That is, the arrival of the optical event from the event source to the optical sensor can be considered to occur instantaneously. Thus some examples the optical To1 time stamp is taken as the baseline of the actual event (e.g. firing) occurrence, as a time stamp that is more accurate than the acoustic time stamp Ta1, and it serves as a trigger for the other calculations.

Assuming that the relative speed of sound is known, in some examples the time difference 620 and the speed of sound can be used to determine the distance D1 of the event source from the acoustic sensor. For example, the time difference can be multiplied by the speed of sound to derive the distance.

In some examples, the system 510 can also classify optical-acoustic-related events (e.g. a gun fires a shot, a door slams) based on associated with optical event(s) To1 (flash) associated with the shot and acoustic events Ta1 (muzzle blast associated with the shot). Note that the muzzle blast and the flash are associated with the same optical-acoustic-related event (a gun fires a shot), at the same point in space, while the shockwave is associated with the movement of the bullet rather than with the instantaneous firing. An optical-acoustic-related event is an event which causes, or is associated with, at least one optical event and at least one acoustic event, i.e. an event that has an acoustical and optical signature.

In some examples, this classification is based on optical patterns associated with the optical events, and on acoustic patterns associated with the acoustic events. In some examples, this enables or facilitates enhanced-accuracy classification of the optical-acoustic-related events, i.e. a classification having enhanced accuracy as compared to a different classification which is based on only one of on optical patterns and acoustic patterns, but not on both types of patterns. This different classification is referred to herein also as a second classification.

Note that solution 505 utilizes sensors of different types, which measure different physical phenomena. A detection and/or location system 510 that utilizes both optical and acoustic sensors, such as exemplified with reference to FIGS. 2, 3, 6 and 7, has at least certain example advantages. When using only acoustic sensors, or only optical sensors, the identification/detection process in some cases has a higher incidence of false positives and/or false negatives. For example, such prior-art solutions have in some cases comparatively high False-Alarm Rates (FAR), and lower Probabilities of Detection (PD), as compared to those associated with an optical-acoustic combined solution.

As one non-limiting example of a false positive, if a police car beacon or light bar is flashing, an optical-only detection/location solution may detect occurrence of an event, the flash, and may in some cases result in a false report of e.g. a gunshot. By contrast, an optical-acoustic combined solution 505 may detect that there is no acoustic event corresponding to the optical event, and thus will not report a gunshot. As another non-limiting example, if an automobile tire blows out, an acoustic-only detection/location solution may detect occurrence of an event, the loud noise, and may in some cases result in a false report of e.g. a gunshot. Again, by contrast, an optical-acoustic combined solution may detect that there is no optical event corresponding to the acoustic event which appears like a gunshot, and thus will not report a gunshot.

In a non-limiting example of a false negative, if for various reasons the sound is detected at a low volume, or the sound is distorted or muffled etc., an acoustic-only solution will not detect the event. Similarly, in some examples, an acoustic-only solution will be misled or confused due to echo, and will not identify the event or will determine the direction incorrectly. A combined optical-acoustic solution 505 can in some cases detect (and classify) occurrence of an optical event, and this information can be utilized to detect this low-volume acoustic event.

Similarly, if for example the lighting environment is such that the optical event is not clear, a combined optical-acoustic solution can in some cases detect occurrence of an acoustic event, and this information can be utilized to detect this unclear optical event. By contrast, an optical-only solution may not detect this unclear optical event. In still another example, a mortar round is fired, but no flash is detected by the optical sensor, e.g. because the mortar uses a muzzle suppressor. Only smoke is detected by the optical sensor. The acoustic sensor, on the other hand, detects a sound which system 510 classifies as a mortar firing. An optical-only solution may not detect this event based on the smoke. However, a combined optical-acoustic solution 505 can in some cases detect occurrence of the acoustic event, e.g. a muzzle blast, and can for example classify it correctly as a mortar firing. Based on that knowledge the system 510 can determine that the detected smoke is in fact associated with a mortar-firing event.

In addition, as will be shown below with reference to FIG. 7, an optical-acoustic combined solution which processes multiple optical events and multiple acoustic events will further increase the PD and decrease the FAR. The matching of optical and acoustic events, to verify the actual occurrence of an event, is performed on a series of events, and thus the statistical probability of correct detection can be increased.

In addition, in some prior-art examples, the event source distance calculation requires detection of both the muzzle blast 120 and the shock wave 150 acoustic events, and/or may require knowledge of the projectile 140 speed. Also, it may not always be possible to distinguish between muzzle blast 120 and the shock wave 150 in the acoustic data 623. By contrast, in some examples combined optical-acoustic solution 505 can detect and locate event sources 110 without detecting e.g. the shock wave 150 acoustic event, or knowing a priori the projectile 140 speed.

In addition, when using acoustic sensors, without optical sensors, to determine distance, the distance is determined based on measuring the time between the shockwave and the blast. In such cases, the accuracy of the measured distance can be proportional to the distance, in some cases in the 10-20% range. Thus, in some cases, the accuracy is in the area of +/−20 to 50 meters, for an event source located about 500 meters (m) away from the acoustic sensor. By contrast, when using both optical and acoustic sensors, the distance accuracy is based at least partly on the degree of synchronization of the clocks of the optical and acoustic sensors 210, 220, and on the sampling rate of the acoustic sensor. The accuracy in that case is based partly on the Signal-to-Noise Ratio (SNR) of the captured data, which is only indirectly related to the distance, and is not proportional to the distance. For at least this reason, an acoustic-only measurement accuracy is lower than the accuracy achievable when using both optical and acoustic sensors, as will be exemplified further herein.

Similarly, in some examples optical sensors do not provide distance information, or do not provide sufficiently accurate distance information, in particular if they do not include a laser distance finder. Thus the optical-domain calculations can benefit from the comparatively greater accuracy provided by the acoustic sensors.

An additional example advantage of the solution of the presently disclosed subject matter is not tailored specifically for detection and location of the firing of weapons. It can be used as-is also for situations such as falling of bombs or projectiles, slamming of doors, vehicles etc. Such a system 505 in some cases is capable of multi-mission and multi-function use, for example detecting and locating events of different types.

Additional example advantages of the presently disclosed subject matter concern determination of the speed of object movement. Consider for example an object such as a bullet or other projectile 140 fired from a weapon 110. The distance D1 of the weapon has been calculated with accuracy, based on the time stamps of the flash 130 and the acoustic-event time stamps of muzzle blast 120. The acoustic time stamp of the associated shockwave 150 can be used, together with calculated distance D1, to determine the speed of the movement 160 of projectile 140. The time stamp of shockwave 150 is thus utilized to provide this additional information. By contrast, in some examples of an acoustic-only solution, the time difference between the shock wave and the muzzle blast, and the distance D1 is calculated based on an assumed speed of projectile 140. In such solutions, the projectile speed is assumed, and cannot be calculated. Attention is now drawn to FIG. 7, schematically illustrating a non-limiting example generalized depiction of optical data 773 and acoustic data 723, in accordance with some embodiments of the presently disclosed subject matter. The figure shows graphs 710 and 760 of acoustic and optical data, respectively, along time axes 725, 775. The Y axes 720, 770 depict the intensity or amplitude of detected signals. In the example, optical events such as firing flashes 130 occurred at times To1, To2, To3, and also at times 740, 744, 748. This exemplifies a case where there are two event sources or weapons 110, 320, e.g. as depicted in FIG. 3, that both fire or generate other optical and acoustic events. In some examples, e.g. in real combat situations, multiple automatic firearms fire simultaneously, e.g. using burst of rapid fire, and there are thus numerous shots fired within a short time from multiple sources.

Note also that the multiple weapons may be of multiple classifications/types or models. In one illustrative example, 110 is an AK-47 and 320 is an Uzi. In another illustrative example, 110 is an AK-47 and 320 is a rapid-fire cannon.

Because in the non-limiting example of the figure, there are two weapons firing, either simultaneously or with a relatively short time interval between them, there are also corresponding additional acoustic events 750, 754, 858 on the acoustic data graph 710. These additional acoustic events are in addition to the acoustic events at times Ta1, Ta2, (and Ta3, not shown) which are associated with weapon 110. In the example of the graph, additional acoustic events 750, 754, 858 represent muzzle blasts 120, and additional shockwaves associated with firing of the second weapon 320 are not shown, for clarity and ease of exposition only.

In addition to exemplifying the presence of two event sources, the graph also exemplifies an event source which generates possibly-similar events multiple times in sequence, e.g. an automatic weapon engaging in automatic fire, of volleys or bursts. In some examples, the graphs 710, 760 represent a brief period of time 725, 775, and the fire is rapid fire. The multiple firings is exemplified by groups of similar events: e.g. To1, To2, To3, or the group Ta1, Ta2, Ta3, or the group Ta11, Ta22, or the group 740, 744, 748, or the group 750, 754, 858.

It is readily observed in FIG. 7 that, given the rapid rate of events, and given the generation of multiple sources, there are multiple shots overlapping in time. In some cases this can make more difficult, for prior art systems, the tasks of detection of the events, the association of corresponding acoustic events with each other and with optical events. For example, the acoustic data also does not indicate which blast acoustic events correlate with which shockwave acoustic events. For example, the blast of a first shot may occur close in time to a shockwave of a second shot. If the sampling rate of the acoustic sensor is too low, prior art systems may be unable to distinguish between each acoustic event that occurred, and thus detect and classify each of these two events.

Similarly, due to the overlap of events in both the acoustic and optical data, it can be difficult for prior systems to associate optical events and corresponding acoustic events.

As a result, this situation can make also the tasks of calculation of distances and directions of event sources more difficult for prior systems. Also, the association of events with event sources 210, 320, and classification of event sources is difficult for prior systems.

It is readily apparent that, an event detection system which relied purely on detecting e.g. acoustic data 723, for example an acoustic-data-only gunshot localization system, would in at least some cases be unable to measure the difference 640 in time between a muzzle blast Ta1 and a shockwave Ta11, so as to e.g. determine distance of the weapon, due to confusion as to which sound events are associated with the same single shot.

In some examples of the presently disclosed subject matter, use of optical and acoustic events can solve this problem. Pattern correlation is performed between the optical gunfire event and the corresponding muzzle blast acoustic gunfire event. The sequence of time differences between e.g. the shots of a single automatic weapon is identical in the acoustic and optical domains. In some examples, correlating these sequences enables the system to detect e.g. which muzzle blast acoustic event correlates with which flash optical event, and to measure their first time difference 620.

In some cases, the optical-acoustic detection and localization system 510 performs the following steps, on the plurality of optical events and of acoustic events:
(a) optionally performing an initial grouping of optical events To1, To2, To3 based on directions C of the optical events and/or optical patterns associated with the optical events, thereby deriving initial group(s) To1, To2, To3 of related optical events.
(b) optionally performing an initial grouping of acoustic events Ta1, Ta2, Ta3 based on directions C of the acoustic events and/or acoustic patterns associated with the optical events, thereby deriving initial group(s) Ta1, Ta2, Ta3 of related acoustic events.
(c) grouping optical events To1, To2, To3 of the plurality of optical events To1, To2, To3, 740, 744, 748, and acoustic events Ta1, Ta2, Ta3 of the plurality of acoustic events Ta1, Ta2, Ta3, Ta11, Ta22, Ta33, 750, 754, 758, based on repetition of first time differences 620, 767 between pairs To1, Ta1, To2, Ta2 of optical events and acoustic events. There is thus derived one or more optical-acoustic groups, e.g. a first group To1, To2, To3, Ta1, Ta2, Ta3 and a separate second group 740, 744, 748, 750, 754, 758.

In some examples this can enable a differentiation of/between multiple event sources 110, 320, based on the grouping, in a situation of overlapping events. In some examples, the above the grouping of the optical events and of the acoustic events comprises at least the following steps:
(i) determining a plurality of first time differences 765, 761, 620, 763, 767 etc., between acoustic-event time stamps Ta11, 750, Ta1, Ta2 etc. of the plurality of acoustic events and an optical-event time stamp To1 of each optical event To1, To2, To3 of the plurality of optical events; and
(ii) identifying the repetition of the first time differences 620, 767 based on the determined plurality of first time differences.

In some examples, the repetition of the time differences correlates to a single event-source distance D2. In some examples, the determination of the event-source distance D2 is based on the repeated first time differences 620, 767 of a particular optical-acoustic group To1, To2, To3, Ta1, Ta2, Ta3.

In some examples, the grouping includes matching individual acoustic events Ta1 of the optical-acoustic group To1, To2, To3, Ta1, Ta2, Ta3 with individual optical events To1 of that optical-acoustic group. In some examples, these individual acoustic events and individual optical events are referred to herein also as second individual acoustic events and second individual optical events.

This example method is now explained in further detail. The plurality of optical events in plot 760 can in some examples be grouped, using an initial grouping, into one or more groups of related optical and/or acoustic events. For example, To1, To2, To3 are members of one group of related optical events, while 740, 744, 748 are members of another such group. In some cases, this grouping of optical events is based on direction C of the associated event source. In one simple example of this, in FIG. 4 it is seen that flashes 413, 423 are occurring in different portions of image 410. Thus, consider a case in which multiple images 410 are analyzed, and in some images flashes are seen in the upper-left of the image, while in other images flashes are seen in the middle-right of the image. The system 510 can readily determine that the upper-left-located flashes are in a related group, while the middle-right-located flashes are in a separate second related group. Note also that direction of the event in some examples correlates with the position of a respective event source 210, 320.

In some examples, grouping of optical events is performed based on the optical patterns associated with the optical events. As one simplified example of this, consider a case in which FIG. 4 depicts 413 as a flash, while 423 is depicted as a puff of smoke. The system 510 can analyze multiple images, and determine that the flash events are in a related group, while the smoke events are in a separate second related group. Other examples of differing optical patterns may exist, e.g. two weapons which have different flash patterns associated with their firing.

In still other examples, system 510 is capable of grouping optical events based both on direction of the event/position of the source, and also on optical patterns.

To distinguish them from other groups disclosed herein, these groups of related optical events are referred to herein also as initial groups of related optical events. The optical events are in some examples referred to as first optical events.

To distinguish them from other groups disclosed herein, these groups of related acoustic events are referred to herein also as initial groups of related acoustic events. The acoustic events are in some examples referred to as first acoustic events.

In some examples, in addition to detecting or identifying the existence of an optical event(s), system 510 is capable of also classifying the optical event(s). For example, classification module 555 can consult data store 570, which contains reference optical data associated with various optical events (e.g. flash, movement of a vehicle or person etc.), and match the received optical data with the stored reference data. For example, there may be certain defined or stored optical patterns associated with a flash or smoke event. The same is true for acoustic events. Once the optional step of deriving initial groups of related optical events To1, To2, To3 is performed, the system can determine a plurality of first time differences 765, 761, 620, 763, 767 etc., between acoustic-event time stamps Ta11, 750, Ta1, Ta2 etc. of the plurality of acoustic events and an optical-event time stamp To1 of each optical event To1, To2, To3 of the plurality of optical events. That is, first time differences between To1 and all (or some) of the acoustic time stamps of graph 710 are determined, first time differences between To2 and all (or some) of the acoustic time stamps of graph 710 are determined, the same is performed for To3, and so on for other optical time stamps (e.g. of the initial grouping).

It can be assumed, in some cases, that if a particular weapon fires several shots when it is located at the same distance D1 from the sensor(s) for all of the shots, the time difference between the optical flash event 130 and the corresponding acoustic muzzle blast event 120 should typically be nearly identical, since the time difference is based on the distance, the speed of light and the speed of sound, and those parameters are constant for the multiple shots. This first time difference 620, across multiple shots, should be more similar to each other, than to other first time differences, associated with other combinations of optical event and acoustic event appearing on the graphs 710, 760.

Reverting to the method, repetition of the first time differences 620, 767 based on the determined plurality of first time differences, is identified. That is, the system 510 can note that time intervals 620 and 767 are close to each other in value, that is are within a defined amount of each other. This defined tolerance is in some cases a system configuration. In some examples the tolerance is defined as a certain number of milliseconds (ms). The system will also determine that the values of intervals 620 and 767 are less close (less similar) to values of other calculated time intervals such as 765, 761, 763, than they are to each other. The system in some cases also determines that values of other time intervals such as 765, 761, 763 are not close to each other. The system concludes that time intervals 620 and 767 are repetitive. In one non-limit illustrative examples, time intervals 620 and 767 are each approximately 100 ms, while the value 763 is approximately 180 ms.

The system 510 can thus group optical events To1, To2, To3 and acoustic events Ta1, Ta2, Ta3, and can derive an optical-acoustic group To1, To2, To3, Ta1, Ta2, T3. In a similar manner, the system can derive a separate optical-acoustic group, one which groups the events 740, 744, 748, 750, 754, 758. In some examples, an optical-acoustic group is referred to herein also as a first optical-acoustic group.

Note also that the time intervals 730, 735, between consecutive muzzle blasts of the same weapon, will be less similar to each other than will first time differences between e.g. To1 and Ta1. This is because the firing rate of even a single weapon has some variation.

Note also that FIG. 7 shows the data 724 of only one acoustic sensor 220. If the graph for e.g. a second acoustic sensor 225 were shown as well, it would be seen that the acoustic event Ta1′ of sensor 225, corresponding to event Ta1 in sensor 220, would be very close in time to Ta1, as compared to time differences associated with acoustic events of different shots of the same or different weapons. Thus Ta1′, Ta2′, Ta3′, associated with sensor 225, can also be grouped into the optical-acoustic group To1, To2, To3, Ta1, Ta2, T3.

In some examples, the grouping includes matching individual acoustic events of an optical-acoustic group with individual optical events of that optical-acoustic group. Thus, events To1 and Ta1 are matched to each other, and it is determined that both are associated with the optical-acoustic event of the firing of weapon 110 at time To1. For example, events To1, Ta1 and Ta11 are associated with the first shot fired, events To2, Ta2 and Ta22 are associated with the second shot fired, etc. Similarly, To2 and Ta2 are matched, 740 and 750 are matched, 744 and 754 are matched etc. In some examples, these matched events are referred to herein as second individual optical events and second individual acoustic events.

In some examples, the determination of the event-source distance D2 of a particular source is based at least on the repeated first time differences 620, 767. As one non-limiting example, the time differences 620, 767 etc. can be averaged, and a distance determined based on the average. Additional disclosure of such distance determination, is presented further herein.

Note that the events of an optical-acoustic group To1, To2, To3, Ta1, Ta2, Ta3. can correlate to a shared event-source distance D2. In a similar manner, the events of another optical-acoustic group 740, 744, 748, 750, 754, 758, correlate to a different shared event-source distance D3.

Note also that an optical-acoustic group can be associated with a specific event source. Thus, in the example, optical-acoustic group To1, To2, To3, Ta1, Ta2, T3 is associated with source 110, while optical-acoustic group 740, 744, 748, 750, 754, 758 is associated with source 320.

Once all events of an optical-acoustic group have been identified, and associated with an event source, also the direction of the event source relative to the sensor(s) can be determined. Note that even if an initial value of the direction C was determined, e.g. using the position of the event source within image 410, the calculation based on the events of the optical-acoustic group can in some cases be more accurate, e.g. by averaging direction calculations performed for each matched pair of optical event and acoustic event. In some examples, this more accurate calculation of direction, based on the events of the group, is referred to herein also as a second direction of the event source, associated with the optical-acoustic group.

In some examples, the second direction is more accurate than the initial direction, because of imperfections in the initial direction determination. For example, acoustic reflections captured at the acoustic sensors 220, 225 can cause errors in the initial direction determination.

Note that the initial grouping disclosed above, based e.g. on initial direction of event source and/or on event pattern, is optional. In some other examples, the method disclosed below can be performed without performing an initial grouping step. In the example of FIG. 7, the system 510 can, for each of the six optical events shown, calculate first time differences relative to each of the eight shown acoustic events, and look for repetitions among all of the 48 resulting time intervals. However, in some cases there is a performance advantage to performing an initial grouping based on e.g. on pattern, to determine that e.g. To1, To2, To3 are associated with a different event source than are 740, 744, 748, and to perform all of the calculations and cross-comparisons of intervals for several smaller groups of data.

In FIG. 7, the fourth time intervals of the shockwave acoustic events Ta11, Ta22 etc. are not shown. Note also that time intervals between consecutive shockwaves Ta11, Ta22, Ta33 are typically close to the corresponding time intervals 730, 735 between consecutive muzzle blasts Ta1, Ta2, Ta3. In some examples these intervals are of a length/value that is similar to the third time intervals 726, 727 and the fourth time intervals 730, 735, and thus also these shockwave acoustic events can be matched to the corresponding flash events and the blast events. Note that in some cases the time intervals between shockwaves 150 will have greater variance than do time intervals between e.g. muzzle blasts 120, and the shockwave time stamps can have more measurement noise.

In some examples, system 510 is configured to also classify acoustic event(s) based on optical events, for example based on associated acoustic-event time stamp(s) and optical-event time stamp(s). For example, assume that To1 and Ta1 have been determined to be corresponding time stamps, and the optical and acoustic events corresponding these time stamps have been associated with each other. If the system 510 has classified that optical event To1 is a flash event of gunfire, based at least on the optical data, the system may then determine that the corresponding acoustic event Ta1 is a muzzle blast event. This process is referred to herein also as classifying optical-acoustic-related events (e.g. a gun fires a shot, a door slams), i.e. events that have an acoustical and optical signature.

Note that in some examples, measuring distance and/or direction of event source(s) based on a plurality of optical and acoustic events (e.g. a plurality of shots fired) can also provide the example advantage of improving accuracy of the measurements, as compared to a case where analysis is performed on optical and acoustic events of only one shot or other event. In the case of only one shot, the time difference is referred to herein also as a second single time difference between a single acoustic-event time stamp and a corresponding single optical-event time stamp.

In one such example, the distance/direction measurements include determining the distance (and/or direction) of the at event source(s) based on the plurality of time differences. Using such a method, the system 510 is in some examples capable of deriving an enhanced-accuracy distance/direction of the at least one event source, having enhanced accuracy compared to a second distance/direction determined based on a second single time difference between a single acoustic-event time stamp and a corresponding single optical-event time stamp.

In some such examples, the time difference determination includes determining time differences between acoustic-event time stamps of the second individual acoustic events and corresponding optical-event time stamps of the second individual optical events, which are associated with a single burst of first, thereby deriving a plurality of time differences. In some such examples, the time difference determination includes calculating an average time difference between the acoustic-event time stamps and the corresponding optical-event time stamps, e.g. averaging the plurality of time differences. In other non-limiting examples, a plurality of distances is calculated based on the plurality of time differences, and the plurality of distances is averaged. In still other non-limiting examples, a plurality of directions is calculated based on the plurality of time differences, and the plurality of directions is averaged.

In some examples, such a method reduces the standard deviation of the distance/direction measurement by a function of the number N of events, e.g. of shots fired by the source. For example, the standard deviation can be inversely proportional to the square root of N. Thus, for common bursts of 4-5 shots, the accuracy is improved by approximately a factor of 2.

In some examples, the distance accuracy of the determined distance in such a case is less or equal to 10 meters. In some examples, the distance accuracy of the determined distance in such a case is less or equal to 1 meter. In some examples, the distance accuracy of the determined distance in such a case is less or equal to 0.1 meter. In some examples, this is achieved at least partly by the time-synchronization between the optical and acoustic sensors.

In some examples, the combination optical-acoustic solution 505 is also capable of overcoming interference of noise in either of the sensor types, and still achieving the required accuracy.

Another example advantage is due to the fact that some optical sensors have a comparatively low frames/second rate, and may thus miss certain optical events.

Note that in this provides the example advantage of enabling distance/direction calculations per each separate event source (e.g. weapon), e.g. in a situation where multiple weapons are shooting at overlapping times. The method can also enable a differentiation of/between multiple event sources 110, 320 in a situation of overlapping events, based on the grouping.

A system without such capabilities, by contrast, would be unable to take the optical data and acoustic data of e.g. FIG. 7, and be able to distinguish which events are associated with which event source, due to the overlap of events. These prior-art systems would thus, in some cases, be unable to perform calculations using event time stamps to determine locations of the multiple event sources, nor to associate events with event sources. In fact, in some cases the prior-art systems would not be able to even determine that the data of FIG. 7 was caused by multiple event sources are involved, and/or how many different event sources are involved. That is, the prior art systems will be unable to differentiation of/between multiple event sources 110, 320 in a situation of overlapping events.

As an illustrative example only, of overlapping or near-simultaneous events, assuming a speed of sound of 300 m/sec, and a weapon distance of 600 m, if shots were fired (e.g. by two different weapons) less than 2 seconds apart from each other, prior art systems would be confused, and would in some cases be unable to distinguish between them. A combined optical-acoustic solution 505, on the other hand, would be able to distinguish between them.

Recall also that, in some examples, classification of optical-acoustic-related events (e.g. a gun firing), which are associated with the optical events and the acoustic events, is performed, e.g. based on both optical patterns associated with the optical events and on acoustic patterns associated with the acoustic events. In some examples, such an optical-acoustic-related event classification is performed with comparatively greater accuracy, when the classification is based on more than one of each event, e.g. based on the optical events To1, To2, To3 and on acoustic events Ta1, Ta2, Ta3. As the patterns are detected an increased number of times, there is increased confidence in the classification. Note that this is not achievable in prior art solutions, which are unable to distinguish between the events in a situation of overlapping events and/or rapid-occurrence (e.g. rapid fire) events.

In some example, the methods disclosed with referent to FIG. 7 can also be used to types of classify event sources. This provides the example advantage of classifying the particular weapon that is shooting. For example, gun types can be classified using the automatic fire rate. Different weapons types have different firing rates, based on their mechanical design. Here are example typical firing rates associated with several weapons, presented for illustrative purposes only:

TABLE 1

| Gun Type | Firing rate (seconds/shot) |
|---|---|
| AK-47 | 0.1 |
| M-16 | 0.086 |
| MAG | 0.06-0.08 |
| Micro Uzi | 0.05 |

In some examples of such a method, system 510 classifies the event source(s) 110, 320 based on a method such as the following:
i. determining third optical-event time intervals associated with a group of optical events of the at least one optical-acoustic group (see details below)
ii. determining fourth acoustic-event time intervals associated with a group of acoustic events of the at least one optical-acoustic group (see details below)
iii. calculating average acoustic time interval(s) and/or average optical time interval(s).
iv. determining an event rate (e.g. a firing rate) based at least on the fourth acoustic-event time intervals and/or on the third optical-event time intervals; and
V. classifying the event source(s) based at least on the determined event rate.

In some examples this classifying of event source(s) is comprises a table lookup, such as Table 1, which may for example be stored in data store 570.

In some examples, the system 510 determines a representative optical-event time interval for each group, e.g. an interval representative of intervals 726 and 727. This interval is referred to herein also as a third optical-event time interval. For example, the system may average the measured time intervals 726, 727 to obtain the representative third optical-event time interval of the group of optical events To1, To2, To3.

Note that different groups of related optical events in some cases have different representative third optical-event time intervals. For example, the third time interval 726, 727 associated with the To1, To2, To3 group can be 100 milliseconds (ms), while the third time interval 728, 729 associated with the 740, 744, 748 group can be 50 milliseconds.

In some examples, the system 510 determines a representative acoustic-event time interval for each group, e.g. an interval representative of intervals 730 and 735. This interval is referred to herein also as a fourth acoustic-event time interval. For example, the system may average the measured time intervals 726, 727 to obtain the representative fourth acoustic-event time interval of the group of acoustic events Ta1, Ta2, Ta3. This representative fourth acoustic-event time interval of the group is referred to herein also as an average acoustic time interval. Similarly, a representative third optical-event time interval of the group, can be calculated, e.g. by averaging. This is referred to herein also as an average optical time interval.

The sequences of time differences between the shots of this single automatic weapon will typically be identical, or near-identical, in both the optical and acoustic domains.

A non-limiting example of matching fourth acoustic-event time intervals with corresponding third optical-event time intervals is presented, for illustrative purposes only. The below Table 2 illustrates the high correlation between the burst sequences record in the optical domain with burst sequences recorded in the acoustic domain, in a sequence of eleven (11) shots:

TABLE 2

| Shot Index | | |
|---|---|---|
| (Number of the | Time difference | Time difference |
| shot within the | from previous | from previous |
| burst) | optical event (sec) | acoustic event (sec) |
| 2 | 0.188 | 0.191 |
| 3 | 0.160 | 0.156 |
| 4 | 0.172 | 0.174 |
| 5 | 0.173 | 0.171 |
| 6 | 0.172 | 0.174 |
| 7 | 0.174 | 0.172 |
| 8 | 0.164 | 0.166 |
| 9 | 0.175 | 0.173 |
| 10 | 0.174 | 0.174 |
| 11 | 0.168 | 0.168 |

Based on the determined third and/or fourth time intervals, an event rate (e.g. a firing rate) can be determined, and the event source(s) can be classified based at least on the determined event rate (e.g. using a lookup of a table such as Table 1).

Note also that this event-source classification, based on comparable-value time intervals, can be accomplished in some examples despite the overlap of fire, and the presence of a plurality of event sources 210, 320, in both optical data 723 and acoustic data 763.

A simple non-limiting illustrative example will be presented, explaining some of the methods associated with multiple overlapping events. Assume that an Uzi is located 41 degrees to the left of the sensor, and it fires from 200 m away. A micro-Uzi is located 45 degrees to the left of the sensor, and it fires from 100 m away. An M-16 is located 42 degrees to the left of the sensor, and it fires from 150 m away. An AK-47 fires from 60 degrees to the left of the sensor. In the initial grouping step, based on direction only, and depending on the accuracy of the sensors, it is possible that the system will group the firing from 60 degrees as one group, and the firing from 41, 42, 45 degrees as a second group. If the system makes use of patterns as well (image and/or acoustic patterns), it may distinguish the M-16 fire as one group, and the firing from the two Uzi models as a second group. For example, the firing of the two Uzi models may have similar patterns in the optical and/or acoustic data. Note that, in either case, the system 510 groups together several shots fired from very differences, but cannot distinguish them from each other.

By applying the methods disclosed above, of grouping events into optical-acoustic groups, e.g. based on repetition of first time differences, the system 510 determines that there are four different weapons, firing from different distances and/or directions. Having distinguished the firing of the two Uzis and the M-16, the system can then calculate for each weapon a more accurate direction (41 vs 42 vs 45 degrees). In addition, if the two models of Uzi have different firing rates, the system 510 can classify each model, even though their optical and acoustic pattern data appeared the same.

The result, in the example, is that the four firing sources have been distinguished from each other, the distance and direction of each from the sensor(s) have been determined, and their individual firing rates and model types have been determined.

And additional example advantage of analyzing multiple events generated by the same event source, e.g. multiple shots fired by the same weapon, is that in some cases it can enable an increased confidence in the classification of the event source. This may be the case where the classification of the acoustic event is imperfect, and is prone to errors. In one non-limiting example, an Uzi is fired 10 times. Analysis of the acoustic patterns of each shots is imperfect. For 8 of the shots, the acoustic pattern is identified correctly as an Uzi, while for 2 of the shots, the pattern is identified incorrectly as an AK-47. Because the presently disclosed subject matter determines an optical-acoustic group To1, To2 . . . . To10, Ta1, Ta2 . . . . Ta10, based e.g. on repetition of first time differences such as Ta1-To1, it is determined that all of the shots were fired by the same weapon, and it is also determined that the firing rate is that of an Uzi. Thus the event source is classified with greater accuracy and confidence, than if the combined optical-acoustic solution 505 was not used, or if the solution did not analyze the burst of multiple shots fired.

Considering again Table 1, in some examples the rate of fire of event source 110 is determined, and the table lookup determines that the event source is not of a known class, e.g. it is not a known weapon that appears on Table 1. In addition, in some cases also the acoustic and/or optical patterns of the firing are not familiar, per the information in data store 570. The method thus has the additional advantage of indicating to the system user that the weapon detected is not of a known type, e.g. it is a home-made or modified weapon. It also indicates to the user the firing rate of this unknown weapon. Note also that in some examples this information can be used, to associate the acoustic and/or optical patterns of the firing of this weapon with the determined firing rate, to be classified as a newly detected category of weapon.

Additional example advantages of the presently disclosed subject matter concern determination of the direction of object movement. Consider for example an object such as a bullet or other projectile 140 fired from a weapon 110. Based on the event/firing rate, it has been determined that the weapon is an M-16. It is assumed that speed of movement of the bullet of an M-16 is known. Based on this known object movement speed information, on the calculated distance D2 of the weapon 110, and on the calculated angle or direction E of the weapon 110, if solution 505 comprises multiple acoustic sensors 220, 225, or e.g. a single acoustic vector-sensor 220, the direction E of firing of the projectile 140, relative to e.g. sensors 220, 225, can be calculated. The direction E of firing is a non-limiting example of the direction E of movement of an object 140. Based on this firing direction calculation, the system 510 can also determine at what target/destination the weapon 110 is firing.

Another example advantage of a combined optical-acoustic solution 505 is the ability to use relatively simple and/or inexpensive components to detect and locate event sources with a specified accuracy. For examples, there may be a need to locate weapons 110 of a particular type (e.g. pistol, sniper rifle etc.), which have typical ranges and thus should be located at a particular distance, e.g. 200 meters, 500 m, 1000 m etc. There may be a need to perform the locating at a specified accuracy, for example dependent on the distance of interest and the nature of the particular weapon/threat/event source. It is possible to choose the correct optical sensor 210, for example with lens optimized for the particular distance, and to choose several microphones or other acoustic sensors 220, 225 of a particular type. It is possible to choose the distance between the acoustic sensors, and their positioning relative to the optical sensor, that is to calibrate the system 505 to be optimized for the accuracy required. The system can be configured, in one non-limiting example, such that the distance measurement will rely mostly on the acoustic sensors, and the direction measurement will rely mostly on the optical sensors. Note that with a diode sensor 210, the complexity of performing image processing (e.g. on a captured camera image) is in some examples not required.

By contrast, when using optical sensors only, a simple diode is in some cases insufficient to provide detection. In some examples, a camera 210 would be needed, along with a full image processing algorithm. Despite this increased complexity and cost of the optical sensor 210, in some examples the camera 210, working alone, provides poorer accuracy in distance measurement than do the cheaper diodes 210 that function in combination with acoustic sensor(s) 220, 225. Cameras typically have a frame rate of dozens to hundreds of frames per second (fps). On the other hand, some diodes have a frame rate on the order of thousands of fps. The higher frame rate allows a more accurate determination of when exactly the optical-acoustic-related event (e.g. firing of the weapon) occurred. Thus these inexpensive diodes can achieve distance calculation accuracies of e.g. 10 m, 1 m or 0.1 m.

It is also noted that increased distance calculation accuracy can also translate into operational improvements. If the distance of the enemy weapon 110 is known with great accuracy, a system for countermeasures can e.g. be configured to automatically set the range and azimuth of friendly weapons and automatically perform counter-fire at enemy weapon 110, in a comparatively quick manner. By contrast, where the distance calculation accuracy is lower (e.g. for an optical-only or acoustic-only solution), additional actions may be required (looking at additional intelligence inputs etc.) before a decision can be made how to set the range and azimuth of friendly weapons. Thus response to the fire 160 may be slower than when using combined optical-acoustic solution 505.

Note that solution 505 utilizes sensors of different types, which measure different physical phenomena. Since the solution 505 utilizes both optical and acoustic sensors, it is in some examples possible to design the system using e.g. a tradeoff between the complexity and/or cost of the optical sensor(s) and of the acoustic sensor(s). For example, in some cases a relatively simple optical sensor, with a wide range of view but poor precision, is sufficient to enable the required solution, because it functions in combination with acoustic sensors. By contrast, a solution utilizing only optical sensors, or only acoustic sensors, might in some cases require sensors of higher complexity and cost, and/or use of a large number of networked sensors, and/or performance of additional calculations.

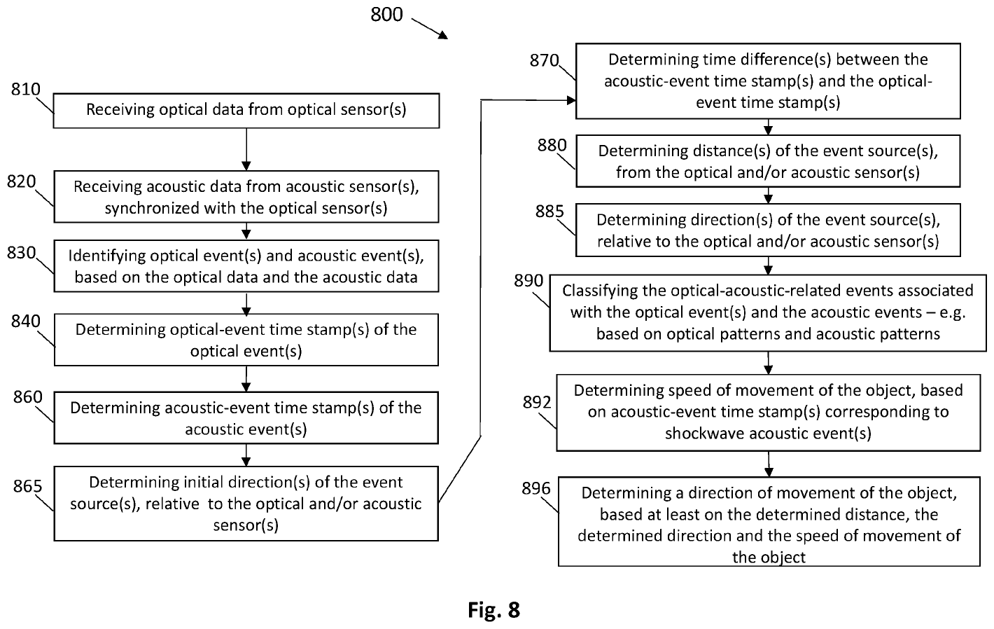

Attention is drawn to FIG. 8, schematically illustrating a non-limiting example of a generalized flow diagram for event source detection and location, in accordance with some embodiments of the presently disclosed subject matter. Flow 800 starts with block 810.

According to some examples, optical data is received from one or more optical sensors (block 810). In some examples, this block utilizes Optical Input Module 532, of the processor 530 of processing circuitry 515 of optical-acoustic detection system 510. In some examples, the optical data is indicative of one or more optical events 130, 313, 323 associated with at least one event source 110, 320. In some examples, the optical data is associated with one or more optical-data time stamps.

According to some examples, acoustic data is received from one or more acoustic sensors (block 820). In some examples, this block utilizes Acoustic Input Module 534. In some examples, the acoustic data is indicative of one or more acoustic events 120, 150, 230, 235 associated with at least one event source 110, 320. In some examples, the acoustic data is associated with one or more acoustic-data time stamps.

In some examples, the optical sensor(s) 210 and the acoustic sensor(s) 220, 225 are synchronized in time.

According to some examples, one or more optical events To1, To2, To3, and one or more acoustic events Ta1, Ta2, Ta3, are identified, based at least on the optical data and on the acoustic data (block 830). In some examples, this block utilizes Optical-Acoustic Identification Module 536. In some examples, in this block, the optical events and/or acoustic events are classified, e.g. based on optical and/or acoustical pattern (e.g. using also data store 570). As one example, an optical event To1 is classified as the flash of a gun firing, based on similarity of optical pattern to known optical patterns stored in database 570.

According to some examples, optical-event time stamp(s) To1, To2, To3 of the one or more optical events To1, To2, To3 are determined (block 840). In some examples, this block utilizes Optical Identification Module 536. In some examples, this is performed based at least on the optical data time stamp(s).

According to some examples, acoustic-event time stamp(s) Ta1, Ta2, Ta3 of the one or more optical events are determined (block 860). In some examples, this block utilizes Acoustic Identification Module 538. In some examples, this is performed based at least on the acoustic data time stamp(s).

According to some examples, an initial direction of the event source(s) 110, relative to the optical and/or acoustic sensors 210, 220, 225, is determined (block 865). In some examples, this block utilizes Distance and Angle Calculation Module 545.

According to some examples, one or more first time differences 620 between the at one acoustic-event time stamp(s) Ta1, Ta2, Ta3 and the at one optical-event time stamp(s) To1, To2, To3 are determined (block 870). In some examples, this block utilizes Time Difference Calculation Module 540.

According to some examples, a distance D1, D2, D3 of the event source(s) 110, 320, from one or more of the optical sensor(s) 210 and the acoustic sensor(s) 220, 225, are determined (block 870). In some examples, this block utilizes Distance and Angle Calculation Module 545. In some examples, this determination is performed based at least on the optical event(s) To1, To2, To3, the acoustic event(s) Ta1, Ta2, Ta3, the optical data and the acoustic data. In some examples, this is performed based at least on the calculated first time difference(s) 620.

According to some examples, a direction of the event source(s) 110, 320, relative to one or more of the optical sensor(s) 210 and the acoustic sensor(s) 220, 225, are determined (block 885). In some examples, this block utilizes Distance and Angle Calculation Module 545. In some examples, this is performed based at least partly, on the optical data and/or on the acoustic data. In some examples, this direction of the event source(s) is referred to herein also as a second direction of the event source(s), to distinguish it from an initial direction determined in block 865. In some examples, the second direction calculation is more accurate than the initial direction which was calculated.

According to some examples, the optical-acoustic-related event(s) are classified (block 890). In some examples, this block utilizes Classification Module 555. In some examples, this utilizes also data store 570. An example of an optical-acoustic-related event is the firing of a gun, which causes a flash 130, a muzzle blast 120 and a shock wave 150, i.e. an event which has an acoustical and optical signature. In some examples, block 890 is based on optical patterns associated with the optical events and acoustic patterns associated with the acoustic events. According to some examples, if relevant, the speed of movement 160 of an object 140, from an event source 110, is determined (block 892). In some examples, this block utilizes Distance and Angle Calculation Module 545. In some examples, this calculation is performed based at least on acoustic-event time stamps Ta11, Ta22, Ta33, associated with shockwave acoustic event(s).

According to some examples, if relevant, direction E of movement 160 of an object 140, from an event source 110, is determined (block 896). In some examples, this block utilizes Distance and Angle Calculation Module 545. In some examples, this calculation is performed based at least on the calculated distance D2 of the event source 110, on the calculated direction C of the event source 110, and on the speed of movement 160 of object 140.

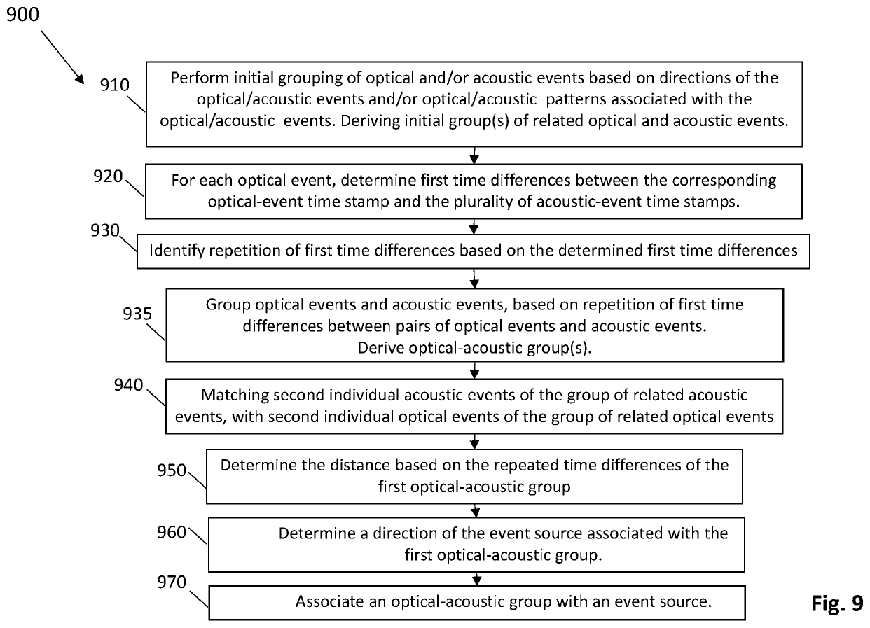

FIG. 9 schematically illustrates a non-limiting example of a generalized flow diagram for event source detection, in accordance with some embodiments of the presently disclosed subject matter. Flow 900 is relevant in the case where there are multiple optical events and multiple acoustic events. In some examples, it is performed as part of block 870, determining time differences between acoustic-event time stamps and optical-event time stamps. Flow 900 starts with block 910.

According to some examples, optical events To1, To2, To3 are grouped into an initial grouping, thereby deriving one or more initial groups of related optical events, and acoustic events Ta1, Ta2, Ta3 are grouped into an initial grouping, thereby deriving one or more initial groups of related acoustic events (block 910). In some examples, this block utilizes Matching and Association Module 550, of the processor 530 of processing circuitry 515 of optical-acoustic detection system 510. In some examples, the grouping is performed based on directions of the optical events To1, To2, To3 and/or on optical patterns associated with the optical events. In some examples, the grouping is performed based on directions of acoustic events Ta1, Ta2, Ta3, and/or on acoustic patterns associated with the acoustic events.

According to some examples, a plurality of first time differences 620, 761, 763, 765 between acoustic-event time stamps Ta1, 750, Ta22, Ta11 and an optical-event time stamp To1 of each optical event are determined (block 920). In some examples, this block utilizes Time Difference Calculation Module 540. For each optical event To1, first time differences are determined between the corresponding optical-event time stamp To1 and the plurality of acoustic-event time stamps Ta1, 750, Ta22, Ta11.

According to some examples, repetition of the first time differences 620, 767 is identified, e.g. based on the determined plurality of first time differences 620, 761, 763, 765 (block 930). In some examples, this block utilizes Time Difference Calculation Module 540. In some other examples, this block utilizes Matching and Association Module 550, or some other module not shown in FIG. 5. In some examples, the repetition of the time differences correlates to a single event-source distance D2.

According to some examples optical events To1, To2, To3 of the plurality of optical events and acoustic events Ta1, Ta2, Ta3 of the plurality of acoustic events are grouped (block 935). One or more optical-acoustic groups are derived. In some examples, this block utilizes Matching and Association Module 550. In some examples, the grouping is performed based on repetition of first time differences 620, 767 between pairs To1 and Ta1, To2 and Ta2 of optical events and acoustic events. In some examples such a grouping process enables enabling a differentiation of multiple event sources 110, 320 in a situation of overlapping events. According to some examples, second individual acoustic events Ta1, Ta2, Ta3, of the group of related acoustic events Ta1, Ta2, Ta3, are matched, with the second individual optical events To1, To2, To3 of the group(s) of related optical events To1, To2, To3 (block 940). In some examples, this block utilizes Matching and Association Module 550.

According to some examples, the distance D2 of the event source 110 is determined, based at least on the repeated first time differences 620, 767 associated with a particular optical-acoustic group To1, To2, To3, Ta1, Ta2, Ta3 (block 950). In some examples, this block utilizes Matching and Association Module 550. In some examples, this block is a special case of block 880, performed in a situation of multiple optical and acoustic events.

According to some examples, a second direction C of the event source(s) 110 is determined, where the event source(s) 110 is associated with a particular optical-acoustic group To1, To2, To3, Ta1, Ta2, Ta3 (block 960). In some examples, this block utilizes Distance and Angle Calculation Module 550. In some examples, this block is a special case of block 885, performed in a situation of multiple optical and acoustic events. In some examples, this second direction determination is more accurate that the initial direction determination performed on block 865. In some examples, block 885 provides a refinement of the initial direction determination performed on block 865.

According to some examples, an optical-acoustic group To1, To2, To3, Ta1, Ta2, Ta3 is associated with an event source 110 (block 970). This block is relevant, in some examples, where there is a plurality of optical-acoustic groups, and a plurality of event sources 110, 320. In some examples, this block utilizes Matching and Association Module 550.

According to some examples, an optical-acoustic group To1, To2, To3, Ta1, Ta2, Ta3 is associated with an event source 110 (block 970). This block is relevant, in some examples, where there is a plurality of optical-acoustic groups, and a plurality of event sources 110, 320. In some examples, this block utilizes Matching and Association Module 550.

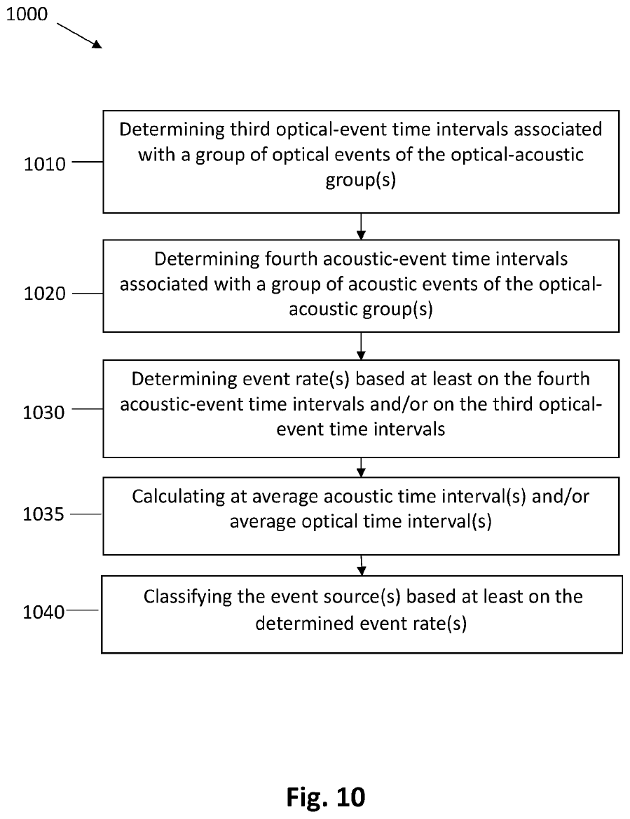

FIG. 10 schematically illustrates a non-limiting example of a generalized flow diagram for event source classification, in accordance with some embodiments of the presently disclosed subject matter. Flow 1000 is relevant in the case where there are multiple optical events and multiple acoustic events. In some examples, it is performed after flow 900. Flow 1000 starts with block 1010.

According to some examples, third optical-event time intervals 726, 727 are determined, (block 1010). These third optical-event time intervals are associated with a group of optical events To1, To2, To3 of the optical-acoustic group(s) To1, To2, To3, Ta1, Ta2, Ta3. In some examples, this block utilizes Time Difference Calculation Module 550, of the processor 530 of processing circuitry 515 of optical-acoustic detection system 510.

According to some examples, fourth acoustic-event time intervals 730, 735 are determined, (block 1020). These fourth acoustic-event time intervals are associated with a group of acoustic events Ta1, Ta2, Ta3 of the optical-acoustic group(s) To1, To2, To3, Ta1, Ta2, Ta3. In some examples, this block utilizes Time Difference Calculation Module 550.

According to some examples, event rate(s) are determined, e.g. based on the fourth acoustic-event time intervals 730, 735 and on the third optical-event time intervals 726, 727 (block 1010). In some examples, this block utilizes Time Difference Calculation Module 550, and/or Classification Module 555.

According to some examples, the event source(s) are classified (block 1040). In some examples, this block utilizes Classification Module 555. In some examples, this is done using a table lookup, e.g. a table in data store 570. In some examples, this is done based on the fourth acoustic-event time intervals 730, 735, and/or on the third optical-event time intervals 726, 727, determined in blocks 1010 and 1020. In some examples, this is done based at least on the event rate determined in block 1030.

Note that the above descriptions of processes 800, 900, 1000 are non-limiting examples only. In some embodiments, one or more steps of the flowcharts exemplified herein are performed automatically. The flow and function illustrated in the flowchart figures may be implemented in system 510 and processing circuitry 515, and may make use of components described with reference to FIGS. 2, 3 and 5. It is also noted that whilst the flowcharts is described with reference to system elements that realize steps, such as for example system 510 and processing circuitry 515, this is by no means binding, and the operations can be carried out by elements other than those described herein.

It is noted that the teachings of the presently disclosed subject matter are not bound by the flowcharts illustrated in the various figures. The operations can occur out the illustrated order. One or more stages illustrated in the figures can be executed in a different order and/or one or more groups of stages can be executed simultaneously. As one non-limiting example, steps 810 and 820, shown in succession, can be executed substantially concurrently, or in a different order. Similarly, in some examples block 885 is performed before blocks 880 and 870. Similarly, some of the operations and steps can be integrated into a consolidation, or can be broken down into several operations, and/or other operations can be added. As one non-limiting example, in some cases steps 830 and 840, can be combined.

In some embodiments of the presently disclosed subject matter, fewer, more and/or different stages than those shown in the figures can be executed. As one non-limiting example, certain implementations may not include block 885 (determining direction), or may not include the blocks of flow 1000.

In the claims that follow, alphanumeric characters and Roman numerals used to designated claim elements such as components and steps, are provide for convenience only, and do not imply any particular order of performing the steps.

It should be noted that the word “compromising” as used throughout the appended claims should be interpreted to mean “including but not limited to”.

While there has been shown disclosed examples in accordance with the presently disclosed subject matter, it will be appreciated that many changes may be made herein without departing from the spirit of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which the disclosure is based may readily utilized as a basis for designing other structures, methods and systems for carrying out the several purposes of the presently disclosed subject matter.

It will also be understood that the system according to the presently disclosed subject matter may be, at least partly, a suitable programmed computer. Likewise, the presently disclosed subject matter contemplates a computer program product being readable by a machine or computer, for executing the method of the presently disclosed subject matter, or any part thereof. The presently disclosed subject matter further contemplates a non-transitory machine-readable or computer-readable memory tangibly embodying a program of instructions executable by the machine or computer, for executing the method of the presently disclosed subject matter, or any part thereof. The presently disclosed subject matter further contemplates a non-transitory machine-readable storage medium having a computer-readable program code embodied therein, configured to execute the method of the presently disclosed subject matter, or any part thereof.

Those skilled in the art will readily appreciate that various modifications and changes can be applied to the embodiments of the invention as hereinbefore described, without departing from its scope, defined in and by the appended claims.

1-50. (canceled)

51. A computerized system configured to detect optical and acoustic events, the system configured to be operatively coupled to at least one optical sensor and at least one acoustic sensor, the computerized system comprising a processing circuitry configured to perform the following method:
(a) receiving optical data from the at least one optical sensor, the optical data being indicative of at least one optical event associated with at least one event source;
(b) receiving acoustic data from the at least one acoustic sensor, the acoustic data being indicative of at least one acoustic event associated with the at least one event source,
wherein the at least one optical sensor and the at least one acoustic sensor are time-synchronized;
(c) identifying the at least one optical event and the at least one acoustic event, based at least on the optical data and on the acoustic data; and
(d) determining at least one of: distance of the at least one event source and a direction of the at least one event source, relative to one or more of the at least one optical sensor and the at least one acoustic sensor,
wherein the determination is based at least on the at least one optical event, the at least one acoustic event, the optical data and the acoustic data.

52. The computerized system of claim 51,
wherein the optical data is associated with at least one optical-data time stamp,
wherein the acoustic data is associated with at least one acoustic-data time stamp,
wherein the determination of the distance in said step (d) comprises performing the following:
(i) determining at least one optical-event time stamp of the at least one optical event, based on the at least one optical-data time stamp;
(ii) determining at least one acoustic-event time stamp of the at least one acoustic event, based on the at least one acoustic-data time stamp;
(iii) determining at least one first time difference between the at least one acoustic-event time stamp and the at least one optical-event time stamp; and
(iv) determining the distance based on the at least one first time difference.

53. The computerized system of claim 51, wherein at least one of the following is true:
(A) the determination of the distance is based on a speed of sound and a speed of light;
(B) the at least one event source is a weapon;
(C) the at least one optical event is associated with a flash of firing of a projectile;
(D) the at least one acoustic event is associated with at least one of: a blast associated with the firing of a projectile, a shock wave associated with the firing of a projectile;
(E) the at least one optical sensor comprises an optical diode;
(F) the at least one optical sensor comprises a camera;
(G) the at least one acoustic sensor comprises a microphone;
(H) the at least one event source comprises one event source;
(I) the at least one event source comprises a plurality of event sources; (J) the determining of the direction of the at least one event source is based at least on the optical data;
(K) a distance accuracy of the determined distance is less or equal to 10 meters;
(L) a distance accuracy of the determined distance is less or equal to 1 meter;
(M) a distance accuracy of the determined distance is less or equal to 0.1 meter; or
(N) the at least one acoustic sensor comprises one acoustic vector sensor, wherein the determining of the direction of the at least one event source is based at least on the acoustic data.

54. The computerized system of claim 51, wherein at least one of the following is true:
the weapon is one of a small arm, an artillery piece, a mortar, a rocket, a missile; or
the weapon is an automatic weapon.

55. The computerized system of claim 51,
wherein the at least one acoustic sensor comprises a plurality of acoustic sensors,
wherein the determining of the direction of the at least one event source is based at least on the acoustic data,
wherein the determining of the direction of the at least one event source is based at least on a first acoustic-event time stamp associated with a first acoustic sensor of the plurality of acoustic sensors and at least one second acoustic-event time stamp associated with at least one other acoustic sensor of the plurality of acoustic sensors.

56. The computerized system of claim 51, wherein at least one of the following is true:
the determining of the direction of the at least one event source is based at least on a second acoustic-event time difference between the first acoustic-event time stamp and the at least one second acoustic-event time stamp; or
the method further comprising:
(e) classifying optical-acoustic-related events associated with the optical event(s) and the acoustic events.

57. The computerized system of claim 51, wherein the classifying is based on optical patterns associated with the optical events and on acoustic patterns associated with the acoustic events, thereby enabling an enhanced-accuracy classification of the optical-acoustic-related events, having enhanced accuracy compared to a second classification which is based on only one of on optical patterns and acoustic patterns.

58. The computerized system of claim 51, wherein at least one of the following is true:
an object is moving from the event source, wherein the event source is a weapon, wherein the object is a projectile fired from the weapon, wherein the method further comprising:
(f) determining a speed of movement of the object, based at least the determined distance and on one or more acoustic-event time stamps corresponding to at least one shockwave acoustic event; or
an object is moving from the event source, wherein the event source is a weapon, wherein the method further comprising:
(g) determining a direction of movement of the object, based at least on the determined distance of the at least one event source, on the direction of the at least one event source and on the speed of movement of the object.

59. The computerized system of claim 52,
wherein at least one of the following is true:
the at least one optical event comprises a plurality of optical events,
wherein the at least one acoustic event comprises a plurality of acoustic events,
wherein said step (d)(iii) comprises determining a plurality of first time differences between acoustic-event time stamps and corresponding optical-event time stamps,
wherein said step (d)(iv) comprises determining the distance of the at least one event source based at least on the plurality of first time differences, thereby deriving an enhanced-accuracy distance of the at least one event source, having enhanced accuracy compared to a second distance determined based on a second single time difference between a single acoustic-event time stamp and a corresponding single optical-event time stamp; or
the at least one optical event comprises a plurality of optical events,
wherein the at least one acoustic event comprises a plurality of acoustic events,
wherein said step (d)(iii) comprises determining a plurality of first time differences between acoustic-event time stamps and corresponding optical-event time stamps,
wherein said step (d)(iv) comprises determining the direction of the at least one event source based at least on the plurality of first time differences, thereby deriving an enhanced-accuracy direction of the at least one event source, having enhanced accuracy compared to a second direction determined based on a second single time difference between a single acoustic-event time stamp and a corresponding single optical-event time stamp.

60. The computerized system of claim 51, wherein at least one of the following is true:
the determining the distance comprises calculating an average of a plurality of determined distances;
the determining the direction comprises calculating an average of a plurality of determined directions; or
the determining of the at least one first time difference comprises calculating an average time difference of the plurality of first time differences.

61. The computerized system of claim 52, wherein the at least one optical event comprises a plurality of optical events, wherein the at least one acoustic event comprises a plurality of acoustic events, wherein the method further comprising:
(h) grouping optical events of the plurality of optical events and acoustic events of the plurality of acoustic events, based on repetition of first time differences between pairs of optical events and acoustic events, thereby deriving at least one optical-acoustic group, thereby enabling a differentiation of multiple event sources, based on the grouping, in a situation of overlapping events.

62. The computerized system of claim 51, wherein at least one of the following is true:
(1) the grouping of the optical events and of the acoustic events comprises:
a. determining a plurality of first time differences between acoustic-event time stamps of the plurality of acoustic events and an optical-event time stamp of each optical event of the plurality of optical events; and
b. identifying the repetition of the first time differences based on the determined plurality of first time differences;
(2) the grouping comprises matching individual acoustic events of the at least one optical-acoustic group with individual optical events of the at least one optical-acoustic group
the determination of the distance in said step (d) is based on the repeated time differences of the at least one optical-acoustic group; or
(3) the determining of the direction of the at least one event source comprises determining a second direction of the event source associated with the at least one optical-acoustic group.

63. The computerized system of the previous claim, wherein the repetition of the time differences correlates to a single event-source distance.

64. The computerized system of claim 61,
wherein at least one of the following is true:
the at least one event source comprises a plurality of event sources,
wherein said step (h) comprises deriving a plurality of optical-acoustic groups,
wherein the method further comprising:
(i) associating an optical-acoustic group of the plurality of optical-acoustic groups with an event source of the plurality of event sources;
the method further comprising performing, prior to said step (h):
(j) perform an initial grouping of optical events based on directions of the optical events and/or optical patterns associated with the optical events, thereby deriving initial group(s) of related optical events.
(k) perform an initial grouping of acoustic events based on directions of the optical events and/or acoustic patterns associated with the acoustic events, thereby deriving initial group(s) of related acoustic events; or
the method further comprising:
(l) determining third optical-event time intervals associated with a group of optical events of the at least one optical-acoustic group;
(m) determining fourth acoustic-event time intervals associated with a group of acoustic events of the at least one optical-acoustic group; and
(n) classifying the at least one event source based at least on the fourth acoustic-event time intervals and/or on the third optical-event time intervals.

65. The computerized system of claim 51,
wherein the classifying of the at least one event source comprises:
i. determining an event rate based at least on the fourth acoustic-event time intervals and/or on the third optical-event time intervals; and
ii. classifying the at least one event source based at least on the determined event rate.

66. The computerized system of claim 51,
wherein at least one of the following is true:
the determining of the event rate comprises calculating at least one of an average acoustic time interval and an average optical time interval; or
the classifying of the at least one event source based at least on the determined event rate comprises a table lookup.

67. The computerized system of claim 61,
wherein said step (d)(iii) comprises determining time differences between acoustic-event time stamps of the second individual acoustic events and corresponding optical-event time stamps of the second individual optical events, thereby deriving a plurality of time differences,
wherein said step (d)(iv) comprises determining at least one of the distance of the at least one event source and the direction of the at least one event source based on the plurality of time differences,
thereby deriving at least one of an enhanced-accuracy distance of the at least one event source and an enhanced-accuracy direction of the at least one event source, having enhanced accuracy as compared to a second distance, and a second direction, determined based on a second single time difference between a single acoustic-event time stamp and a corresponding single optical-event time stamp. (Original) The computerized system of the previous claim, wherein the determining the time differences comprises calculating an average time difference between the acoustic-event time stamps and the corresponding optical-event time stamps.

68. A system comprising:
I. the computerized system of claim 51;
II. the at least one optical sensor; and
III. the at least one acoustic sensor.

69. A computerized method of detecting optical and acoustic events, the method performed by a computerized system comprising a processing circuitry, the computerized system configured to be operatively coupled to at least one optical sensor and at least one acoustic sensor, the method being performed by the processing circuitry and comprising performing the following:
(a) receiving optical data from the at least one optical sensor, the optical data being indicative of at least one optical event associated with at least one event source;
(b) receiving acoustic data from the at least one acoustic sensor, the acoustic data being indicative of at least one acoustic event associated with the at least one event source, wherein the at least one optical sensor and the at least one acoustic sensor are time-synchronized;
(c) identifying the at least one optical event and the at least one acoustic event, based at least on the optical data and on the acoustic data; and
(d) determining at least one of: distance of the at least one event source and a direction of the at least one event source, relative to one or more of the at least one optical sensor and the at least one acoustic sensor, wherein the determination is based at least on the at least one optical event, the at least one acoustic event, the optical data and the acoustic data.

70. A non-transitory computer readable storage medium tangibly embodying a program of instructions which, when executed by a computerized system configured to be operatively coupled to at least one optical sensor and at least one acoustic sensor, cause the computerized system to perform a method of detecting optical and acoustic events, the method being performed by a processing circuitry of the computerized system, the method comprising performing the following:
(a) receiving optical data from the at least one optical sensor, the optical data being indicative of at least one optical event associated with at least one event source;
(b) receiving acoustic data from the at least one acoustic sensor, the acoustic data being indicative of at least one acoustic event associated with the at least one event source, wherein the at least one optical sensor and the at least one acoustic sensor are time-synchronized;
(c) identifying the at least one optical event and the at least one acoustic event, based at least on the optical data and on the acoustic data; and
(d) determining at least one of: distance of the at least one event source and a direction of the at least one event source, relative to one or more of the at least one optical sensor and the at least one acoustic sensor, wherein the determination is based at least on the at least one optical event, the at least one acoustic event, the optical data and the acoustic data.
